(19) United States
(12) Patent Application Publication
(10) Pub. No.: US 2024/0057602 A1
(43) Pub. Date: Feb. 22, 2024

(54) DIAMIDE INSECTICIDE COMPOSITIONS

(71) Applicants: FMC Corporation, Philadelphia, PA (US); FMC Agro Singapore Pte. Ltd., Singapore (SG)

(72) Inventors: Ubiratan F. DESOUSA, Glenn Mills, PA (US); Forrest DURGIN, Newark, DE (US); Robert KENNEDY, West Chester, PA (US); Sergiy PELESHANKO, Hockessin, DE (US); Savka STOEVA, Hockessin, DE (US); Luis TEIXEIRA, Haddonfield, NJ (US); Guozhi WANG, Oakland Gardens, NY (US); Laibin Bruce YAN, North Wales, PA (US)

(21) Appl. No.: 17/766,249

(22) PCT Filed: Oct. 2, 2020
(86) PCT No.: PCT/US20/53915

§ 371 Date: Apr. 3, 2022

Related U.S. Application Data
(60) Provisional application No. 62/910,300, filed on Oct. 3, 2019.

(51) Int. Cl. A01N 43/56; A01N 25/04; A01P 7/04

(52) U.S. Cl. CPC A01N 43/56; A01N 25/04; A01P 7/04

(57) ABSTRACT

Oil concentrate diamide insecticide compositions comprising a phosphate ester is provided. Also provided are tank mix compositions comprising a diamide insecticide, a phosphate ester and a diluent. The compositions may optionally comprise adjuvants such as surfactants, emulsifiers, petroleum-based crop oils, crop-derived seed oils, acidifiers, buffers, thickeners, spreader stickers, and/or defoaming agents. The tank mix compositions are useful for efficacious control of phytophagous insects in agronomic and non-agronomic applications.

### CROSS-REFERENCE TO RELATED APPLICATIONS

This application claims the benefit of U.S. Provisional Application No. 62/910,300 filed Oct. 3, 2019.

### FIELD OF THE DISCLOSURE

The disclosure relates to diamide insecticide compositions for the protection of agricultural crops and uses thereof. Specifically, insecticide oil dispersion composition, emulsifiable concentrate compositions, dispersible concentrate compositions, suspension concentrate compositions and, suspoemulsion compositions are disclosed.

### BACKGROUND OF THE DISCLOSURE

The control of phytophagous invertebrate pests is extremely important in achieving high crop efficiency. Damage by invertebrate pests to growing and stored agronomic crops can cause significant reduction in productivity and thereby result in increased costs to the consumer.

Diamide insecticides are known to be efficacious against phytophagous pests. Diamide insecticides are ryanodine receptor (RyR) modulators that kill insects through the unregulated activation of RyR resulting in muscle paralysis. Insects exposed to cyantraniliprole become lethargic and paralyzed, and eventually die. Diamide insecticides are systemic and are active via both ingestion and contact routes.

Improved diamide insecticide concentrate compositions are desired in order to provide for high loading thereby allowing for reduced packaging, reduced shipping and handling costs, and reduced material disposal. Similarly, adjuvants are desired that improve diamide insecticide efficacy thereby providing for optimized delivery, lower application rates and reduced environmental burden, and the like.

### SUMMARY OF THE DISCLOSURE

In some aspects of the disclosure, an insecticidal oil concentrate composition is provided. The composition comprises: (1) from about 2 wt. % to about 50 wt. % of a at least one diamide insecticide active ingredient; and (2) a phosphate ester of formula (I)

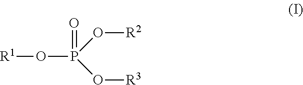

wherein R¹ is a straight-chain or branched alkyl having from 4 to 12 carbon atoms, or a phenyl group optionally substituted with from 1 to 3 C₁₋₄ straight-chain or branched alkyl groups, and R² and R³ are each independently a straight-chain or branched alkyl having from 2 to 8 carbon atoms, or a phenyl group optionally substituted with from 1 to 3 C₁₋₄ straight-chain or branched alkyl groups. The weight ratio of the phosphate ester to diamide insecticide is from about 0.1:1 to about 20:1, except when the diamide insecticide is cyantraniliprople, the weight ratio of the phosphate ester to cyantraniliprople is from about 0.4:1 to about 20:1.

In some aspects of the disclosure, a tank mix formulation is provided comprising the above insecticidal oil concentrate composition and a diluent, wherein the diamide insecticide concentration is less than 5 wt. %, from about 0.005 wt. % to about 4 wt. %, from about 0.01 wt. % to about 1 wt. %, from about 0.01 wt. % to about 0.1 wt. %, or from about 0.01 wt. % to about 0.05 wt. %.

In some aspects of the disclosure, a method of controlling phytophagous pests on plants is provided. The method comprises applying the above-recited tank mix to a plurality of the plants, wherein the tank mix is applied to the plants at a rate sufficient to achieve a total amount of applied diamide insecticide of from about 50 grams per hectare to about 500 grams per hectare, and wherein the mortality of a plurality of the sucking pests is at least 75% evaluated at three days after exposure to the active ingredient.

In some aspects of the disclosure, a tank mix formulation is provided. The tank mix comprises: (1) less than 5 wt. % of a diamide insecticide active ingredient; (2) a phosphate ester of formula (I)

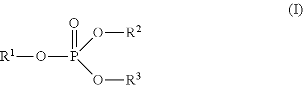

wherein R¹ is a straight-chain or branched alkyl having from 4 to 12 carbon atoms, or a phenyl group optionally substituted with from 1 to 3 C₁₋₄ straight-chain or branched alkyl groups, and R² and R³ are each independently a straight-chain or branched alkyl having from 2 to 8 carbon atoms, or a phenyl group optionally substituted with from 1 to 3 C₁₋₄ straight-chain or branched alkyl groups; and (3) a diluent. The weight ratio of the phosphate ester to diamide insecticide is from about 0.1:1 to about 100:1, except when the diamide insecticide is cyantraniliprople, the weight ratio of the phosphate ester to cyantraniliprople is from about 0.4:1 to about 100:1.

In some aspects of the disclosure, a method of controlling phytophagous pests on plants is provided. The method comprises applying the above-recited tank mix to a plurality of the plants, wherein the tank mix is applied to the plants at a rate sufficient to achieve a total amount of applied diamide insecticide of from about 50 grams per hectare to about 500 grams per hectare, and wherein the mortality of a plurality of the sucking pests is at least 75% evaluated at three days after exposure to the active ingredient.

In some aspects of the disclosure, a method of controlling phytophagous pests on plants is provided. The method comprises applying a composition recited herein to a plurality of the plants, wherein the composition is applied to the plants via an unmanned areal vehicle (“UAV”) at a rate sufficient to achieve a total amount of applied diamide insecticide of from about 10 grams per hectare to about 500 grams per hectare, and wherein the mortality of a plurality of the sucking pests is at least 75% evaluated at three days after exposure to the active ingredient. As used herein, UAV refers generally to any unmanned or remotely piloted vehicle or system.

In aspects some of the disclosure, a method of controlling phytophagous pests on plants is provided. The method comprises applying a composition recited herein to a plurality of the plants, wherein the composition is applied to the plants via an unmanned areal vehicle at a rate sufficient to achieve a total amount of applied diamide insecticide of from about 10 grams per hectare to about 50 grams per hectare, and wherein the mortality of a plurality of the sucking pests is at least 75% evaluated at three days after exposure to the active ingredient.

In some aspects of the disclosure, a method of controlling phytophagous pests on plants is provided. The method comprises applying a composition recited herein to a plurality of the plants, wherein the composition is applied to the plants via an unmanned areal vehicle at a rate sufficient to achieve a total amount of applied diamide insecticide of from about 15 grams per hectare to about 30 grams per hectare, and wherein the mortality of a plurality of the sucking pests is at least 75% evaluated at three days after exposure to the active ingredient.

In some aspects of the disclosure, a method of controlling phytophagous pests on plants is provided. The method comprises applying a composition recited herein to a plurality of the plants, wherein the composition is applied to the plants via an unmanned areal vehicle at a rate sufficient to achieve a total amount of applied diamide insecticide of from about 2 grams per hectare to about 150 grams per hectare, and wherein the mortality of a plurality of the sucking pests is at least 75% evaluated at three days after exposure to the active ingredient.

### DETAILED DESCRIPTION OF THE DISCLOSURE

The present disclosure is generally directed to insecticidal compositions comprising from about 2 wt. % to about 50 wt. % of a diamide insecticide and a phosphate ester, where the weight ratio of phosphate ester to diamide insecticide is from about 0.1:1 to about 20:1, except when the diamide insecticide is cyantraniliprople, the weight ratio of the phosphate ester to cyantraniliprople is from about 0.4:1 to about 20:1. The dispersion concentrate compositions may further comprise one or more adjuvants selected from a non-exclusive list including wetting agents, dispersants, emulsifiers, defoaming agents, diluents, oils, and combinations thereof.

The present disclosure is further generally directed to insecticidal compositions, such as tank mixes, comprising less than 5 wt. % of a diamide insecticide, water, and a phosphate ester, where the weight ratio of phosphate ester to diamide insecticide is from about 0.1:1 to about 100:1, except when the diamide insecticide is cyantraniliprople, the weight ratio of the phosphate ester to cyantraniliprople is from about 0.4:1 to about 20:1. The tank mix compositions may further comprise one or more adjuvants selected from a non-exclusive list including wetting agents, dispersants, emulsifiers, defoaming agents, diluents, crop oils, and combinations thereof. In some such aspects, the tank mix compositions may be prepared by diluting dispersion concentrate compositions of the present disclosure in water, and optionally adding one or more adjuvants such as crop oil. In some other such aspects, the tank mix compositions may be directly prepared by combining a source of the diamide insecticide, a source of the phosphate ester, water, and one or more adjuvants such as wetting agents, dispersants, emulsifiers, defoaming agents, diluents, crop oils, and combinations thereof.

The present disclosure is further directed to methods of controlling phytophagous plant pests by applying a biologically effective amount of compositions of the present disclosure or diluted compositions of the present disclosure to a plurality of plants in order to control the pests.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claims. The term “consisting essentially of” occupies a middle ground between “comprising” and “consisting of”.

Where applicants have defined an embodiment or a portion thereof with an open-ended term such as “comprising,” it should be readily understood that (unless otherwise stated) the description should be interpreted to also describe such an embodiment using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

It also is understood that any numerical range recited herein includes all values from the lower value to the upper value. For example, if a weight ratio range is stated as 1:50, it is intended that values such as 2:40, 10:30, or 1:3, etc., are expressly enumerated in this specification. These are only examples of what is specifically intended, and all possible combinations of numerical values between and including the lowest value and the highest value enumerated are to be considered to be expressly stated in this application.

As used herein, the term “biologically effective amount” refers to the amount of a diamide insecticide sufficient to produce the desired biological effect when applied to (i.e. contacted with) an invertebrate pest to be controlled or its environment, or to a plant, the seed from which the plant is grown, or the locus of the plant (e.g., growth medium) to protect the plant from injury by the invertebrate pest.

As referred to in this disclosure, the term “invertebrate pest” includes arthropods, gastropods, nematodes and helminths of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes members of the phylum Nematoda, such as phytophagous nematodes and helminth nematodes parasitizing animals. The term “helminth” includes all of the parasitic worms, such as roundworms (phylum Nematoda), heartworms (phylum Nematoda, class Secernentea), flukes (phylum Platyhelminthes, class Tematoda), acanthocephalans (phylum Acanthocephala), and tapeworms (phylum Platyhelminthes, class Cestoda).

As used herein, the terms “phytophagous insect” and “phytophagous pest” refer to invertebrate pests causing injury to plants by feeding upon them, such as by eating foliage, stem, leaf, fruit or seed tissue or by sucking the vascular juices of plants.

As used herein, “tank mix” refers to a composition prepared by mixing at least one pesticidal ingredient in a commercially available form with an adjuvant and optionally a quantity of water in a tank by a user immediately before application.

As used herein, “premix” refers to a composition prepared by mixing at least one pesticidal ingredient in a commercially available form with an adjuvant and optionally a quantity of water. Pre-mix as disclosed herein is defined as a mixture two or more biologically active agents (pesticides). In one aspect, a pre-mix may be sold in one package. In one aspect, a pre-mix may further comprise one more adjuvants such as surfactants, emulsifying agents, petroleum-based crop oils, crop-derived seed oils, pH adjusters, thickeners, spreader stickers and/or defoaming agents, as described elsewhere herein.

Spray dilution as disclosed herein is defined as a composition comprising one or more biologically active agents diluted in water or another carrier suitable for spraying, such as but not limited to petroleum and vegetable derived oils

As used herein, the terms “control” and “controlling” refer to killing phytophagous pests or inhibiting phytophagous pest development (including mortality, feeding reduction, and/or mating disruption) of such pests that have infested a plurality of plants. “Control” and “controlling” may also refer to preventing an infestation of phytophagous pests in a plurality of plants.

The term “agronomic” refers to the production of field crops such as for food and fiber and includes without limitation the growth of maize or corn, soybeans and other legumes, rice, cereal (e.g., wheat, oats, barley, rye and rice), leafy vegetables (e.g., lettuce, cabbage, and other cole crops), fruiting vegetables (e.g., tomatoes, pepper, eggplant, crucifers and cucurbits), potatoes, sweet potatoes, grapes, cotton, tree fruits (e.g., pome, stone and citrus), small fruit (e.g., berries and cherries) and other specialty crops (e.g., canola, sunflower and olives).

The term “nonagronomic” refers to other than field crops, such as horticultural crops (e.g., greenhouse, nursery or ornamental plants not grown in a field), residential, agricultural, commercial and industrial structures, turf (e.g., sod farm, pasture, golf course, lawn, sports field, etc.), wood products, stored product, agro-forestry and vegetation management, public health (i.e. human) and animal health (e.g., domesticated animals such as pets, livestock and poultry, undomesticated animals such as wildlife) applications.

The terms “combinations thereof” and “mixtures thereof” as used herein refer to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

The term “emulsifiable concentrate” (EC) refers to a liquid, homogeneous formulation to be applied as an emulsion after dilution in water. EC formulations can further be diluted with water in a spray tank to form a spontaneous emulsion.

The term“dispersible concentrate” (DC) refers to a liquid homogeneous formulation to be applied as a solid dispersion after dilution with water. DC formulations can be diluted with water in the spray tank to form a suspension concentrate (SC).

The term “oil dispersible” (OD) formulation refers to a formulation comprising a solid active ingredient dispersed in oil.

The term “suspoemulsion” (SE) refers to a formulation that combines two active ingredients with very different physical properties into one formulation.

A first embodiment describes an insecticidal oil concentrate composition, the composition comprising:
(1) from about 2 wt. % to about 50 wt. % of a at least one diamide insecticide active ingredient; and
(2) a phosphate ester of formula (I)

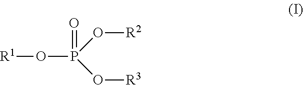

wherein
   R¹ is a straight-chain or branched alkyl having from 4 to 12 carbon atoms, or a phenyl group optionally substituted with from 1 to 3 C₁₋₄ straight-chain or branched alkyl groups, and
   R² and R³ are each independently a straight-chain or branched alkyl having from 2 to 8 carbon atoms, or a phenyl group optionally substituted with from 1 to 3 C₁₋₄ straight-chain or branched alkyl groups,
wherein the weight ratio of the phosphate ester to diamide insecticide is from about 0.1:1 to about 20:1, except when the diamide insecticide is cyantraniliprople, the weight ratio of the phosphate ester to cyantraniliprople is from about 0.4:1 to about 20:1.

A second embodiment describes a composition of the first embodiment, wherein the diamide insecticide is selected from the group consisting of chlorantraniliprole, cyantraniliprole, tetrachlorantraniliprole, bromoantraniliprole, dichlorantraniliprole, tetraniliprole, cyclaniliprole, cyhalodiamide and flubendiamide.

A third embodiment describes a composition of any one of the first or second embodiments, wherein the concentrate is selected from an oil dispersion composition, an emulsifiable concentrate composition, a dispersible concentrate composition, a suspension concentrate composition, and a suspoemulsion.

A fourth embodiment describes a composition of any one of the first to third embodiments, further comprising at least one additional pest control agent.

A fifth embodiment describes the composition of the fourth embodiment, wherein the additional pest control agent selected from an insecticide, a herbicide, a bactericide, a fungicide, a nematicide, and combinations thereof.

A sixth embodiment describes a composition of the fifth embodiment, wherein the insecticide is selected from abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos-methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cycloprothrin, cycloxaprid ((5S,8R)-1-[(6-chloro-3-pyridinyl)methyl]-2,3,5,6,7,8-hexahydro-9-nitro-5,8-Epoxy-1H-imidazo[1,2-a]azepine), cyenopyrafen, cyflumetofen, cyfluthrin, beta-cyfluthrin, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy)phenoxy]-4-quinolinyl methyl carbonate), flonicamid, fluazaindolizine, flucythrinate, flufenerim, flufenoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, tau-fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, oxamyl, oxazosulfyl, parathion, parathion-methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ⁴-sulfanylidene]cyanamide), tebufenozide, tebufenpyrad, teflubenzuron, tefluthrin, kappa-tefluthrin, terbufos, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entomopathogenic fungi, can combinations thereof.

A seventh embodiment describes a composition of any one of the first to sixth embodiments, wherein the phosphate ester is selected from the group consisting of trixylenyl phosphate, butylatated phenol phosphate, tris(isopropylphenyl) phosphate, cresyl diphenyl phosphate, isopropylphehyl diphenyl phosphate, t-butylphenyl diphenyl phosphate, 2-ethylhexyl, diphenyl phosphate, iosdecyl diphenyl phosphate, tri-n-butyl phosphate, tri-n-pentyl phosphate, tri-n-hexyl phosphate, tri-n-heptyl phosphate, tri-n-octyl phosphate, nonyl dioctyl phosphate, butyl dioctyl phosphate, dibutyl nonyl phosphate, butan-2-yl dibutyl phosphate, butan-2-yl diethyl phosphate, butan-2-yl bis(2-methylpropyl) phosphate, 3-methylbutyl dipropan-2-yl phosphate, tris-(2-ethylhexyl)phosphate, tri-iso-butyl phosphate, tributoxylethyl phosphate, and combinations thereof.

An eighth embodiment describes a composition of the seventh embodiment, wherein the phosphate ester is selected from tris-(2-ethylhexyl)phosphate, tri-n-octyl phosphate, and tri-iso-butyl phosphate.

A ninth embodiment describes a composition of the eighth embodiment, wherein the phosphate ester is tris-(2-ethylhexyl)phosphate.

A tenth embodiment describes a composition of any one of the first to ninth embodiments, wherein the weight ratio of phosphate ester to diamide insecticide is from about 0.5:1 to about 15:1, from about 0.75:1 to about 10:1, from about 1:1 to about 5:1, or from about 1.5:1 to about 3:1.

An eleventh embodiment describes a composition of any one of the first to tenth embodiments, wherein the concentration of diamide insecticide active ingredient is from about 10 wt. % to about 40 wt. %, from about 15 wt. % to about 40 wt. %, from about 20 wt. % to about 35 wt. %, from about 25 wt. % to about 35 wt. %, or is about 30 wt. %.

A twelfth embodiment describes a composition of any one of the first to eleventh embodiments, further comprising from about 5 wt. % to about 65 wt. %, from about 5 wt. % to about 40 wt. %, from about 5 wt. % to about 35 wt. %, or from about 10 wt. % to about 30 wt. %, of at least one surfactant.

A thirteenth embodiment describes a composition of any one of the first to twelfth embodiments, wherein the surfactant is selected from: polyether-modified polysiloxanes; copolymers of polyolefin; polyoxyethylene sorbitol fatty acid esters; alkyl benzene sulfonates; alcohol ethoxylates; alcohol mixed ethoxylates and propoxylates; oxirane surfactants; polyglycerol esters and fatty acid esters; oil; and combinations thereof.

A fourteenth embodiment describes a composition of any one of the first to eleventh embodiments, wherein the diamide insecticide is chlorantraniliprole.

A fifteenth embodiment describes a composition of the fourteenth embodiment, further comprising at least one non-ionic surfactant and at least one anionic surfactant, wherein the total surfactant content is from about 5 wt. % to about 60 wt. %, from about 5 wt. % to about 50 wt. %, from about 5 wt. % to about 40 wt. %, from about 5 wt. % to about 35 wt. %, from about 10 wt. % to about 35 wt. %, from about 5 wt. % to about 35 wt. %, from about 15 wt. % to about 35 wt. %, from about 15 wt. % to about 30 wt. %, from about 20 wt. % to about 25 wt. %.

A sixteenth embodiment describes a composition of the fifteenth embodiment, wherein:
the nonionic surfactant content is from about 2 wt. % to about 35 wt. %, from about 5 wt. % to about 30 wt. %, from about 10 wt. % to about 25 wt. %, from about 12.5 wt. % to about 20 wt. %, or from about 12.5 wt. % to about 17.5 wt. %; and
the anionic surfactant content is from about 2 wt. % to about 25 wt. %, from about 2.5 wt. % to about 20 wt. %, from about 2.5 wt. % to about 15 wt. %, from about 2.5 wt. % to about 10 wt. %, or from about 5 wt. % to about 10 wt. %.

A seventeenth embodiment describes a composition of any one of the fifteenth or sixteenth embodiments, wherein:
the nonionic surfactant comprises (i) a random copolymer of polyolefin and polyethylene glycol, (ii) a polyoxyethylene sorbitol fatty acid ester, and (iii) at least one of a polyether-modified polysiloxane, a polyalkyleneoxide silane/alcohol an ethoxylate, alkyl-mixed ethoxylate/propoxylate, an ethylhexanol-mixed ethoxylate/propoxylate, and an alcohol ethoxylate, and
the anionic surfactant comprises alkylbenzene sulfonate,
wherein the nonionic surfactant content is from about 12.5 wt. % to about 17.5 wt. % and the anionic surfactant content is from about 5 wt. % to about 10 wt. %.

An eighteenth embodiment describes a composition of any one of the first to eleventh embodiments, wherein the diamide insecticide is cyantraniliprole.

A nineteenth embodiment describes a composition of the eighteenth embodiment, further comprising at least one non-ionic surfactant and at least one anionic surfactant, wherein the total surfactant content is from about 10 wt. % to about 65 wt. %, from about 15 wt. % to about 60 wt. %, or from about 20 wt. % to about 40 wt. %.

A twentieth embodiment describes a composition of any one of the eighteenth or nineteenth embodiments, further comprising an oil, wherein the total oil content is from about from about 10 wt. % to about 40 wt. %, from about 10 wt. % to about 30 wt. %, or from about 10 wt. % to about 20 wt. %.

A twenty-first embodiment describes a composition of any one of the nineteenth or twentieth embodiments, wherein:
the nonionic surfactant content is from about 10 wt. % to about 60 wt. %, from about 15 wt. % to about 55 wt. %, from about 15 wt. % to about 35 wt. %, or from about 15 wt. % to about 30 wt. %; and
the anionic surfactant content is from about 2 wt. % to about 20 wt. %, or from about 4 wt. % to about 15 wt. %.

A twenty-second embodiment describes a composition of any one of the nineteenth to twenty-first embodiments, wherein:
the nonionic surfactant comprises (i) butyl block copolymer, (ii) polyglycerol esters and (iii) fatty acid esters; and
the anionic surfactant comprises (i) dodecylbenzenesulphonic acid, calcium salt, (ii) poly(12-hydroxystearic acid) and (iii) sodium dioctyl sulfosuccinate,
wherein the nonionic surfactant content is from about 15 wt. % to about 55 wt. % and the anionic surfactant content is from about 2 wt. % to about 15 wt. %.

A twenty-third embodiment describes a composition of the first embodiment comprising:
about 16.8 wt. % cyantraniliprole;
about 42 wt. % TEHP;
about 12.2 wt. % PEG-30 castor oil surfactant;
about 6.2 wt. % linear dodecylbenzenesulphonic acid surfactant;
about 1.6 wt. % poly(12-hydroxystearic acid) surfactant; and
about 21.1 wt. % isoparaffin oil.

A twenty-fourth embodiment describes a composition of the first embodiment comprising:
about 17.3 wt. % cyantraniliprole;
about 43 wt. % TEHP;
about 12.6 wt. % PEG-30 castor oil surfactant;
about 6.4 wt. % linear dodecylbenzenesulphonic acid surfactant;
about 1.7 wt. % poly(12-hydroxystearic acid) surfactant;
about 5.3 wt. % propylene carbonate; and
about 13.7 wt. % isoparaffin oil.

A twenty-fifth embodiment describes a composition of the first embodiment comprising:
about 20.6 wt. % cyantraniliprole;
about 43.6 wt. % TEHP;
about 15 wt. % PEG-30 castor oil surfactant;
about 10 wt. % linear dodecylbenzenesulphonic acid surfactant;
about 3 wt. % poly(12-hydroxystearic acid) surfactant; and
about 8 wt. % ethoxylated alcohol based on cetostearyl alcohol.

A twenty-sixth embodiment describes a composition of the first embodiment comprising:
about 20.6 wt. % cyantraniliprole;
about 46 wt. % TEHP;
about 15 wt. % PEG-30 castor oil surfactant;
about 10 wt. % linear dodecylbenzenesulphonic acid surfactant;
about 3 wt. % poly(12-hydroxystearic acid) surfactant; and
about 5 wt. % polyether-modified polysiloxane surfactant.

A twenty-seventh embodiment describes a composition of the first embodiment comprising:
about 30 wt. % chlorantraniliprole;
about 45 wt. % TEHP;
about 2 wt. % random copolymer of polyolefin and polyethylene oxide surfactant;
about 8 wt. % alkylbenzene sulfonate surfactant;
about 10 wt. % polyoxyethylene (50) sorbitol hexaoleate surfactant; and
about 5 wt. % polyether-modified polysiloxane surfactant.

A twenty-eighth embodiment describes a composition of the first embodiment comprising:
about 30 wt. % chlorantraniliprole;
about 45 wt. % TEHP;
about 2 wt. % random copolymer of polyolefin and polyethylene oxide surfactant;
about 8 wt. % alkylbenzene sulfonate surfactant;
about 10 wt. % polyoxyethylene (50) sorbitol hexaoleate surfactant; and
about 5 wt. % C₁₂₋₁₄ secondary ethoxylated alcohol surfactant.

A twenty-ninth embodiment describes a composition of the first embodiment comprising:
about 30 wt. % chlorantraniliprole;
about 45 wt. % TEHP;
about 2 wt. % random copolymer of polyolefin and polyethylene oxide surfactant;
about 8 wt. % alkylbenzene sulfonate surfactant;
about 10 wt. % polyoxyethylene (50) sorbitol hexaoleate surfactant; and
about 5 wt. % 2-ethyl hexanol EO-PO surfactant.

A thirtieth embodiment describes a composition of the first embodiment comprising:
about 30 wt. % chlorantraniliprole;
about 45 wt. % TEHP;
about 2 wt. % random copolymer of polyolefin and polyethylene oxide surfactant;
about 8 wt. % alkylbenzene sulfonate surfactant;
about 10 wt. % polyoxyethylene (50) sorbitol hexaoleate surfactant; and
about 5 wt. % polyalkyleneoxide silane and alcohol ethoxylate surfactant.

A thirty-first embodiment describes a composition of the first embodiment comprising:
about 30 wt. % chlorantraniliprole;
about 45 wt. % TEHP;
about 2 wt. % random copolymer of polyolefin and polyethylene oxide surfactant;
about 8 wt. % alkylbenzene sulfonate surfactant;
about 10 wt. % polyoxyethylene (50) sorbitol hexaoleate surfactant; and about 5 wt. % oxirane, 2-methyl-, polymer with oxirane, mono(2-propylheptyl) ether surfactant.

A thirty-second embodiment describes a tank mix formulation comprising a composition of any one of the first to thirty-first embodiment and a diluent, wherein the diamide insecticide concentration is less than 5 wt. %, from about 0.005 wt. % to about 4 wt. %, from about 0.01 wt. % to about 1 wt. %, from about 0.01 wt. % to about 0.1 wt. %, or from about 0.01 wt. % to about 0.05 wt. %.

A thirty-third embodiment describes a tank mix formulation of the thirty-second embodiment. wherein the diluent comprises water.

A thirty-fourth embodiment describes a tank mix formulation of any one of the thirty-second or thirty-third embodiments, further comprising at least one tank mix adjuvant.

A thirty-fifth embodiment describes a tank mix formulation of the thirty-fourth embodiment, wherein the at least one adjuvant is crop oil.
A thirty-sixth embodiment describes a tank mix formulation comprising: (1) less than 5 wt. % of a diamide insecticide active ingredient;
(2) a phosphate ester of formula (I)

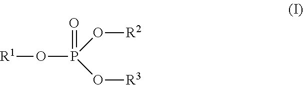

wherein
   R¹ is a straight-chain or branched alkyl having from 4 to 12 carbon atoms, or a phenyl group optionally substituted with from 1 to 3 C₁₋₄ straight-chain or branched alkyl groups, and
   R² and R³ are each independently a straight-chain or branched alkyl having from 2 to 8 carbon atoms, or a phenyl group optionally substituted with from 1 to 3 C₁₋₄ straight-chain or branched alkyl groups; and
(3) a diluent,
wherein the weight ratio of the phosphate ester to diamide insecticide is from about 0.1:1 to about 100:1, except when the diamide insecticide is cyantraniliprople, the weight ratio of the phosphate ester to cyantraniliprople is from about 0.4:1 to about 100:1.

A thirty-seventh embodiment describes a tank mix formulation of the thirty-sixth embodiment, wherein the diluent comprises water.

A thirty-eighth embodiment describes a tank mix formulation of any one of the thirty-sixth or thirty-seventh embodiments, wherein the diamide insecticide is selected from the group consisting of chlorantraniliprole, cyantraniliprole and flubendiamide.

A thirty-eighth embodiment describes a tank mix formulation of any one of the thirty-sixth to thirty-eighth embodiments, wherein the phosphate ester is selected from the group consisting of trixylenyl phosphate, butylatated phenol phosphate, tris(isopropylphenyl) phosphate, cresyl diphenyl phosphate, isopropylphehyl diphenyl phosphate, t-butylphenyl diphenyl phosphate, 2-ethylhexyl, diphenyl phosphate, iosdecyl diphenyl phosphate, tri-n-butyl phosphate, tri-n-pentyl phosphate, tri-n-hexyl phosphate, tri-n-heptyl phosphate, tri-n-octyl phosphate, nonyl dioctyl phosphate, butyl dioctyl phosphate, dibutyl nonyl phosphate, butan-2-yl dibutyl phosphate, butan-2-yl diethyl phosphate, butan-2-yl bis(2-methylpropyl) phosphate, 3-methylbutyl dipropan-2-yl phosphate, tris-(2-ethylhexyl)phosphate, tri-iso-butyl phosphate, and combinations thereof.

A fortieth embodiment describes a tank mix formulation of the thirty-ninth embodiment, wherein the phosphate ester is selected from tris-(2-ethylhexyl)phosphate, tri-n-octyl phosphate, and tri-iso-butyl phosphate.

A forty-first embodiment describes a tank mix formulation of the fortieth embodiment, wherein the phosphate ester is tris-(2-ethylhexyl)phosphate.

A forty-second embodiment describes a tank mix formulation of any one of the thirty-sixth to forty-first embodiments, wherein the ratio of phosphate ester to diamide insecticide is from about 0.5:1 to about 20:1, from about 0.5:1 to about 15:1, from about 0.75:1 to about 10:1, from about 1:1 to about 5:1, or from about 1.5:1 to about 3:1.

A forty-third embodiment describes a tank mix formulation of any one of the thirty-sixth to forty-second embodiments, wherein the concentration of diamide insecticide active ingredient is from about 0.005 wt. % to about 4 wt. %, from about 0.01 wt. % to about 1 wt. %, from about 0.01 wt. % to about 0.1 wt. %, or from about 0.01 wt. % to about 0.05 wt. %.

A forty-fourth embodiment describes a tank mix formulation of any one of the thirty-sixth to forty-third embodiments, further comprising at least one surfactant.

A forty-fifth embodiment describes a tank mix formulation of any one of the thirty-sixth to forty-fourth embodiments, further comprising at least one tank mix adjuvant.

A forty-sixth embodiments describes a tank mix formulation of the forty-fifth embodiment, wherein the at least one adjuvant is crop oil.

A forty-seventh embodiment describes a tank mix formulation of any one of the thirty-sixth to forty-sixth embodiments, wherein the diamide insecticide is chlorantraniliprole.

A forty-eighth embodiment describes a tank mix formulation of any one of the thirty-sixth to forty-sixth embodiments, wherein the diamide insecticide is cyantraniliprole.

A forty-ninth embodiment describes a tank mix formulation of any one of the thirty-sixth to forty-eighth embodiments, further comprising at least one additional pest control agent.

A fiftieth embodiment describes a tank mix formulation of the forty-ninth embodiment, wherein the additional pest control agent selected from an insecticide, a herbicide, a bactericide, a nematicide, fungicide and combinations thereof.

A fifty-first embodiment describes a tank mix formulation of the fiftieth embodiment, wherein the insecticide is selected from abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos-methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cycloprothrin, cycloxaprid ((5S,8R)-1-[(6-chloro-3-pyridinyl)methyl]-2,3,5,6,7,8-hexahydro-9-nitro-5,8-Epoxy-1H-imidazo[1,2-a]azepine), cyenopyrafen, cyflumetofen, cyfluthrin, beta-cyfluthrin, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy)phenoxy]-4-quinolinyl methyl carbonate), flonicamid, fluazaindolizine, flucythrinate, flufenerim, flufenoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, tau-fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, oxamyl, oxazosulfyl, parathion, parathion-methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ⁴-sulfanylidene]cyanamide), tebufenozide, tebufenpyrad, teflubenzuron, tefluthrin, kappa-tefluthrin, terbufos, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entomopathogenic fungi, can combinations thereof.

A fifty-second embodiment describes a method of controlling phytophagous pests on plants, the method comprising applying a tank mix of any one of the thirty-sixth to fifty-first embodiments to a plurality of the plants,
wherein the tank mix is applied to the plants at a rate sufficient to achieve a total amount of applied diamide insecticide of from about 50 grams per hectare to about 500 grams per hectare, and
wherein the mortality of a plurality of the sucking pests is at least 75% evaluated at three days after exposure to the active ingredient.

A fifty-third embodiment describes a method of the fifty-second embodiment, wherein the plant is a food crop, a turf grass, or an ornamental.

A fifty-fourth embodiment describes a method of any one of the fifty-second or fifty-third embodiments, wherein the phytophagous pest is selected from the insect orders, including Hemiptera, Thysanoptera, Orthoptera, Lepidoptera, Coleoptera, Heteroptera, Hymenoptera, and Diptera.

A fifty-fifth embodiment describes a method of any one of the fifty-second to fifty-fourth embodiments, wherein the plurality of plants are infested with the phytophagous pests prior to application of the amide insecticide.

A fifty-sixth embodiment describes a method of any one of the fifty-second to fifty-fourth embodiments, wherein the plurality of plants are not infested with the phytophagous pests prior to application of the amide insecticide.

A fifty-seventh embodiment describes a method of controlling phytophagous pests on plants, the method comprising applying a biologically effective amount of the tank mix of any one of the thirty-sixth to fifty-first embodiments to a plurality of the plants,
wherein the tank mix is applied to the plants at a rate sufficient to achieve a total amount of applied diamide insecticide of from about 50 grams per hectare to about 500 grams per hectare, and
wherein the mortality of a plurality of the sucking pests is at least 75% evaluated at three days after exposure to the active ingredient.

A fifty-eighth embodiment describes a method of the fifty-seventh embodiment, wherein the plant is a food crop, a turf grass, or an ornamental.

A fifty-ninth embodiment describes a method of any one of the fifty-seventh or fifty-eighth embodiments, wherein the phytophagous pest is selected from the insect orders, including Hemiptera, Thysanoptera, Orthoptera, Lepidoptera, Coleoptera, Heteroptera, Hymenoptera, and Diptera.

A sixtieth embodiment describes a method of any one of the fifty-seventh to fifty-ninth embodiments, wherein the plurality of plants are infested with the phytophagous pests prior to application of the amide insecticide.

A sixty-first embodiment describes a method of any one of the fifty-seventh to fifty-ninth embodiments, wherein the plurality of plants are not infested with the phytophagous pests prior to application of the amide insecticide.

A sixty-second embodiment describes a composition of the first embodiment comprising:
about 30 wt. % chlorantraniliprole;
about 45.5 wt. % TEHP;
about 2 wt. % random copolymer of polyolefin and polyethylene oxide surfactant;
about 6 wt. % alkylbenzene sulfonate surfactant;
about 10 wt. % polyoxyethylene (50) sorbitol hexaoleate surfactant;
about 5 wt. % oxirane, 2-methyl-, polymer with oxirane, mono(2-propylheptyl) ether surfactant;
about 1 wt % of a silicone dioxide, and about 0.5 wt % of a polymeric dispersant.

Insecticidal Active

The active agent of the compositions of the present disclosure is a diamide insecticide. Non-limiting examples of such diamides include of chlorantraniliprole, cyantraniliprole, tetrachlorantraniliprole, bromoantraniliprole, dichlorantraniliprole, tetraniliprole, cyclaniliprole, cyhalodiamide and flubendiamide.

Under one theory, and without being bound to any particular theory, it is believed that diamide insecticides activate the ryanodine receptor (RyR) via stimulation of the release of calcium stores from the Sarcoplasmic reticulum of muscle cells of susceptible phytophagous insects (i.e., chewing pests) resulting in impaired regulation, paralysis and death. Effective systemic concentrations of diamide insecticides in phytophagous insects results primarily by ingestion, and secondarily by contact.

In some aspects, the diamide insecticide is chlorantraniliprole. In some other aspects, the diamide insecticide is cyantraniliprole. In some other aspects, the diamide insecticide is tetraniliprole. In some other aspects, the diamide insecticide is flubendiamide.

The diamide insecticide concentration in the insecticidal concentrate compositions of the present disclosure may be, on an active ingredient basis, about 4 wt. %, about 5 wt. %, about 10 wt. %, about 15 wt. %, about 20 wt. %, about 25 wt. %, about 30 wt. %, about 35 wt. %, about 40 wt. %, about 45 wt. % or about 50 wt. %, and ranges constructed therefrom, such as from about 4 wt. % to about 50 wt. %, from about 4 wt. % to about 40 wt. %, from about 10 wt. % to about 50 wt. %, from about 10 wt. % to about 40 wt. %, from about 15 wt. % to about 40 wt. %, from about 20 wt. % to about 35 wt. %, or from about 25 wt. % to about 35 wt. %.

In some particular chlorantraniliprole aspects, the concentrate compositions may comprise about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, or about 40 wt. % chlorantraniliprole.

In some other chlorantraniliprole aspects, the concentrate compostions may comprise a chlorantraniliprole concentration of 20.0 wt. %, 20.1 wt. %, 20.2 wt. %, 20.3 wt. %, 20.4 wt. %, 20.5 wt. %, 20.6 wt. %, 20.7 wt. %, 20.8 wt. %, 20.9 wt. %, 21.0 wt. %, 21.1 wt. %, 21.2 wt. %, 21.3 wt. %, 21.4 wt. %, 21.5 wt. %, 21.6 wt. %, 21.7 wt. %, 21.8 wt. %, 21.9 wt. %, 22.0 wt. %, 22.1 wt. %, 22.2 wt. %, 22.3 wt. %, 22.4 wt. %, 22.5 wt. %, 22.6 wt. %, 22.7 wt. %, 22.8 wt. %, 22.9 wt. %, 23.0 wt. %, 23.1 wt. %, 23.2 wt. %, 23.3 wt. %, 23.4 wt. %, 23.5 wt. %, 23.6 wt. %, 23.7 wt. %, 23.8 wt. %, 23.9 wt. %, 24.0 wt. %, 24.1 wt. %, 24.2 wt. %, 24.3 wt. %, 24.4 wt. %, 24.5 wt. %, 24.6 wt. %, 24.7 wt. %, 24.8 wt. %, 24.9 wt. %, 25.0 wt. %, 25.1 wt. %, 25.2 wt. %, 25.3 wt. %, 25.4 wt. %, 25.5 wt. %, 25.6 wt. %, 25.7 wt. %, 25.8 wt. %, 25.9 wt. %, 26.0 wt. %, 26.1 wt. %, 26.2 wt. %, 26.3 wt. %, 26.4 wt. %, 26.5 wt. %, 26.6 wt. %, 26.7 wt. %, 26.8 wt. %, 26.9 wt. %, 27.0 wt. %, 27.1 wt. %, 27.2 wt. %, 27.3 wt. %, 27.4 wt. %, 27.5 wt. %, 27.6 wt. %, 27.7 wt. %, 27.8 wt. %, 27.9 wt. %, 28.0 wt. %, 28.1 wt. %, 28.2 wt. %, 28.3 wt. %, 28.4 wt. %, 28.5 wt. %, 28.6 wt. %, 28.7 wt. %, 28.8 wt. %, 28.9 wt. %, 29.0 wt. %, 29.1 wt. %, 29.2 wt. %, 29.3 wt. %, 29.4 wt. %, 29.5 wt. %, 29.6 wt. %, 29.7 wt. %, 29.8 wt. %, 29.9 wt. %, or 30.0 wt. %.

In some particular cyantraniliprole aspects, the concentrate compositions may optionally contain a cyantraniliprole concentration of about 4 wt. %, about 10 wt. %, about 15 wt. %, about 20 wt. %, about 25 wt. %, about 30 wt. %, about 35 wt. %, about 40 wt. %, about 45 wt. %, or about 50 wt. % of the active, and ranges constructed therefrom, such as from about 4 wt. % to about 50 wt. %, from about 4 wt. % to about 40 wt. %, from about 10 wt. % to about 50 wt. %, from about 10 wt. % to about 40 wt. %, from about 15 wt. % to about 40 wt. %, from about 15 wt. % to about 35 wt. %, or from about 20 wt. % to about 30 wt. %.

The diamide insecticide concentration in aqueous tank mix compositions of the present disclosure is suitably less than 5 wt. %, such as about 0.005 wt. % (50 ppm), about 0.01 wt. % (100 ppm), about 0.02 wt. % (200 ppm), about 0.03 wt. % (300 ppm), about 0.04 wt. % (400 ppm), about 0.05 wt. % (500 ppm), about 0.1 wt. % (1000 ppm), about 0.5 wt. % (5000 ppm), about 1 wt. %, about 2 wt. %, about 3 wt. %, or about 4 wt. %, and ranges constructed therefrom, such as from about 0.005 wt. % to about 3 wt. %, from about 0.01 wt. % to about 1 wt. %, from about 0.01 wt. % to about 0.1 wt. %, or from about 0.01 wt. % to about 0.05 wt. %.

Phosphate Esters

Based on experimental evidence to date, it has been discovered that phosphate esters allow for the preparation of stable diamide insecticide oil dispersion concentrate compositions having an active content of 5 percent by weight (“wt.”) or more. In such aspects, phosphate esters function as the oil component. More particularly, it has been discovered that phosphate esters improve the dispersability of diamide insecticides in oil dispersion concentrate compositions while allowing for high insecticide loading and a spontaneous oil dispersion bloom when combined with water.

Further based on experimental evidence to date, it has been discovered that phosphate esters provided for improved efficacy on phytophagous insects thereby allowing for reduce application rates of diluted or tank mix formulations of diamide insecticides. Under one theory, and without being bound to any particular theory, it is believed that phosphate esters function as penetrants to improve laminar translocation of foliar applied diamide insecticides systemically into the plant.

It is yet further believed that phosphate esters improve the rainfastness of applied diamide insecticides.

Phosphate esters (also be termed phosphoric esters) within the scope of the present disclosure are shown as Formula I below:

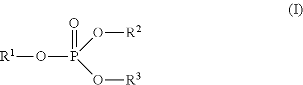

where R¹ is a straight-chain or branched alkyl having 4 to 12 carbon atoms, or phenyl optionally substituted with 1 to 3 C₁₋₄ straight-chain or branched alkyl groups. R² and R³ are each independently a straight-chain or branched alkyl having 2 to 8 carbon atoms, or phenyl optionally substituted with 1 to 3 C₁₋₄ straight-chain or branched alkyl groups.

In some aspects, R¹ is: n-butyl; i-butyl; sec-butyl; t-butyl; n-pentyl; n-hexyl; 2-ethyl-hexyl; n-heptyl; n-octyl; i-octyl; n-nonyl; i-nonyl; n-decyl; n-dodecyl; i-dodecyl; phenyl; 3-methyl phenyl; 2,4-dimethyl phenyl; isopropyl phenyl; or t-butyl phenyl.

In some aspects, R² and R³ are independently: n-butyl; i-butyl; sec-butyl; t-butyl; n-pentyl; n-hexyl; 2-ethyl-hexyl; n-heptyl; n-octyl; i-octyl; phenyl; 3-methyl phenyl; 2,4-dimethyl phenyl; isopropyl phenyl; or t-butyl phenyl.

Non-limiting examples of phosphate esters within the scope of the present disclosure include: trixylenyl phosphate, butylatated phenol phosphate, tris(isopropylphenyl) phosphate, cresyl diphenyl phosphate, isopropylphehyl diphenyl phosphate, t-butylphenyl diphenyl phosphate, 2-ethylhexyl, diphenyl phosphate, iosdecyl diphenyl phosphate, tri-n-butyl phosphate, tri-n-pentyl phosphate, tri-n-hexyl phosphate, tri-n-heptyl phosphate, tri-n-octyl phosphate, nonyl dioctyl phosphate, butyl dioctyl phosphate, dibutyl nonyl phosphate, butan-2-yl dibutyl phosphate, butan-2-yl diethyl phosphate, butan-2-yl bis(2-methylpropyl) phosphate, 3-methylbutyl dipropan-2-yl phosphate, tris-(2-ethylhexyl)phosphate (“TEHP”), and tri-iso-butyl phosphate (“TIBP”), tributoxyethyl phosphate, and combinations thereof. In some aspects, the phosphate ester is selected from TEHP, tri-n-octyl phosphate, and TIPB. In some particular aspects, the phosphate ester is TEHP.

Phosphate esters within the scope of the present disclosure are considered to be insoluble in water having an aqueous solubility of less than 0.1 g/L, less than 0.05 g/L or less than 0.01 g/L. The phosphate esters therefore function as the continuous oil phase in the diamide oil dispersion compositions of the present disclosure.

The weight ratio of phosphate ester to diamide insecticide in the concentrate compositions of the present disclosure, except when the diamide insecticide is cyantraniliprole, is suitably about 0.1:1, about 0.2:1, about 0.3:1, about 0.4:1, about 0.5:1, about 0.75:1, about 1:1, about 1.25:1, about 1.5:1, about 2:1, about 3:1, about 4:1, about 5:1, about 7.5:1, about 10:1, about 12.5:1, about 15:1, about 17.5:1 or about 20:1, and ranges constructed therefrom, such as for instance, from about 0.1:1 to about 20:1, from about 0.4:1 to about 20:1, from about 0.5:1 to about 15:1, from about 0.75:1 to about 10:1, from about 1:1 to about 5:1, or from about 1.5:1 to about 3:1. In some aspects, the weight ratio of phosphate ester to diamide insecticide is from about 0.5:1 to about 15:1, from about 0.75:1 to about 10:1, from about 1:1 to about 5:1, or from about 1.5:1 to about 3:1.

The weight ratio of phosphate ester to diamide insecticide in tank mix compositions of the present disclosure, except when the diamide insecticide is cyantraniliprole, is suitably about 0.1:1, about 0.2:1, about 0.3:1, about 0.4:1, about 0.5:1, about 0.75:1, about 1:1, about 1.25:1, about 1.5:1, about 2:1, about 3:1, about 4:1, about 5:1, about 7.5:1, about 10:1, about 12.5:1, about 15:1, about 17.5:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1 or about 100:1, and ranges constructed therefrom, such as for instance, from about 0.1:1 to about 100:1, from about 0.1:1 to about 50:1, from about 0.1:1 to about 20:1, from about 0.4:1 to about 20:1, from about 0.5:1 to about 15:1, from about 0.75:1 to about 10:1, from about 1:1 to about 5:1, or from about 1.5:1 to about 3:1. In some aspects, the weight ratio of phosphate ester to diamide insecticide is from about 0.5:1 to about 15:1, from about 0.75:1 to about 10:1, from about 1:1 to about 5:1, or from about 1.5:1 to about 3:1.

Where the diamide insecticide is cyantranilipriole, the weight ratio of phosphate ester to cyantraniliprole in the concentrate compositions of the present disclosure is suitably about 0.4:1, about 0.5:1, about 0.75:1, about 1:1, about 1.25:1, about 1.5:1, about 2:1, about 3:1, about 4:1, about 5:1, about 7.5:1, about 10:1, about 12.5:1, about 15:1, about 17.5:1 or about 20:1, and ranges constructed therefrom, such as for instance, from about 0.4:1 to about 20:1, from about 0.5:1 to about 15:1, from about 0.75:1 to about 10:1, from about 1:1 to about 5:1, or from about 1.5:1 to about 3:1.

Where the diamide insecticide is cyantraniliprole, the weight ratio of phosphate ester to diamide insecticide in tank mix compositions of the present disclosure is suitably about 0.4:1, about 0.5:1, about 0.75:1, about 1:1, about 1.25:1, about 1.5:1, about 2:1, about 3:1, about 4:1, about 5:1, about 7.5:1, about 10:1, about 12.5:1, about 15:1, about 17.5:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1 or about 100:1, and ranges constructed therefrom, such as for instance, from about 0.4:1 to about 100:1, from about 0.4:1 to about 50:1, from about 0.4:1 to about 20:1, from about 0.5:1 to about 15:1, from about 0.75:1 to about 10:1, from about 1:1 to about 5:1, or from about 1.5:1 to about 3:1. In some aspects, the weight ratio of phosphate ester to diamide insecticide is from about 0.5:1 to about 15:1, from about 0.75:1 to about 10:1, from about 1:1 to about 5:1, or from about 1.5:1 to about 3:1.

The phosphate ester concentration in the insecticidal concentrate compositions of the present disclosure may be about 2 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, or about 80 wt. %, and ranges constructed therefrom, such as from about 2 wt. % to about 80 wt. %, from about 5 wt. % to about 75 wt. %, from about 5 wt. % to about 40 wt. %, from about 5 wt. % to about 20 wt. %, from about 10 wt. % to about 70 wt. %, from about 10 wt. % to about 35 wt. %, from about 15 wt. % to about 70 wt. %, from about 20 wt. % to about 40 wt. %, from about 20 wt. % to about 65 wt. %, from about 25 wt. % to about 60 wt. %, from about 25 wt. % to about 65 wt. %, from about 30 wt. % to about 60 wt. %, from about 35 wt. % to about 55 wt. %, from about 50 wt. % to about 60 wt. %, or from about 40 wt. % to about 50 wt. %. In some aspects, the phosphate ester concentration is about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, or about 50 wt. %.

The phosphate ester concentration in aqueous tank mix compositions of the present disclosure is suitably about 0.002 wt. % (20 ppm) about 0.005 wt. % (50 ppm), about 0.01 wt. % (100 ppm), about 0.025 wt. % (250 ppm) about 0.05 wt. % (500 ppm), about 0.1 wt. % (1000 ppm), about 0.5 wt. % (5000 ppm), about 1 wt. %, about 2.5 wt. %, about 5 wt. %, about 7.5 wt. %, or about 10 wt. %, and ranges constructed therefrom, such as from about 0.002 wt. % to about 10 wt. %, from about 0.01 wt. % to about 5 wt. %, from about 0.01 wt. % to about 1 wt. %, or from about 0.01 wt. % to about 0.5 wt. %.

Surfactants

The compositions of the present disclosure may comprise one or more surfactants. Surfactants generally modify, most often reduce, the surface tension of the liquid. Depending on the nature of the hydrophilic and lipophilic groups in a surfactant molecule, surfactants can be useful as wetting agents, dispersants, emulsifiers and/or defoaming agents. Surfactants within the scope of the present disclosure include nonionic surfactants, anionic surfactants, cationic surfactants, zwitterionic (amphoteric) surfactants, and combinations thereof. In some aspects, the compositions of the present disclosure comprise a nonionic surfactant component comprising at least one nonionic surfactant and an anionic surfactant component comprising at least one anionic surfactant.

Nonionic Surfactant Component

The compositions of the present disclosure may comprise one or more nonionic surfactants. Non-limiting examples of nonionic surfactants include alkoxylates, fatty alcohol alkoxylates, siloxanes/silicones, alkylphenol alkoxylates, fatty acid alkoxylates, alkoxylated amines, alkoxylated fatty acid amides, terminally blocked alkoxylates, fatty acid esters of polyhydroxy compounds, fatty acid esters of glycerol, fatty acid esters of sorbitol, fatty acid esters of sucrose, alkylpolyglucosides, amine oxide, and combinations thereof. Alkoxy groups may suitably be ethoxy, propoxy, or a combination of ethoxy and propoxy groups in random or block configuration.

In more detail, non-limiting examples of nonionic surfactants include: alcohol alkoxylates (such as alcohol alkoxylates based on natural and synthetic alcohols (which may be branched or linear) and prepared from the alcohols and ethylene oxide, propylene oxide, butylene oxide or mixtures thereof); amine ethoxylates, alkanolamides and ethoxylated alkanolamides; alkoxylated triglycerides (such as ethoxylated soybean, castor and rapeseed oils); alkylphenol alkoxylates (e.g., octyl—(such as the Triton® X series), nonyl—(such as the Tergitol® HP series), dinonyl-, or dodecyl-)); ethoxylated fatty acids; ethoxylated fatty esters and oils (such as Break Thru® SP 133); ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers (such as block polymers prepared from ethylene oxide or propylene oxide and reverse block polymers where the terminal blocks are prepared from propylene oxide; ethoxylated fatty acids), alkyd PEG (polyethylene glycol) resins, alkyd type copolyesters, graft or comb polymers, and star polymers; polyethylene glycols (PEG); polyethylene glycol fatty acid esters; silicone-based surfactants; sugar-derivatives such as sucrose esters, alkyl polyglycosides and alkyl polysaccharides; and combinations thereof.

In some aspects, the nonionic surfactant component comprises at least one nonionic surfactant selected from sorbitan fatty acid esters, polyethoxylated sorbitan fatty acid esters, sorbitol ethoxylate esters, alkylpyrrolidones, and combinations thereof. Non-limiting examples of sorbitan fatty acid esters include sorbitan monolaurates (e.g., Span™ 20), sorbitan monopalmitates (e.g., Span™ 40), sorbitan monostearates (e.g., Span™ 60), sorbitan tristearates (e.g., Span™ 65), sorbitan monooleates (e.g., Span™ 80), sorbitan trioleates (e.g., Span™ 85), and combinations thereof. Non-limiting examples of polyethoxylated sorbitan fatty acid esters include Tween® 20, Tween® 21, Tween® 40, Tween® 60, Tween® 80, and Surfonic® L24-4. Non-limiting examples of alkylpyrrolidones include Surfadone™ LP-100 (N-otcyl-2-pyrrolidinone) and Surfadone™ LP-300 (N-dodecyl-2-pyrrolidinone). Non-limiting examples of sorbitol ethoxylate esters that may be suitable for the biopesticides described herein include polyoxyethylene sorbitol oleates (e.g., Arlatone® TV), polyoxyethylene sorbitol hexaoleates (e.g., Cirrasol® G-1086), polyoxyethylene sorbitol hexaoleates (e.g., Cirrasol® G-1096), polyoxyethylene oleate-laurates (e.g., Atlox 1045AR®), and combinations thereof. Polyethoxylated sorbitan fatty acid esters and sorbitol ethoxylate esters having a degree of ethoxylation of 20, 30, 40, 50, 60, 70 or 80 are generally suitable. In one such aspect, the nonionic surfactant is Cirrasol® G-1086 (polyoxyethylene (40) sorbitol hexaoleate). In another such aspect, the nonionic surfactant is Cirrasol® G-1096 (polyoxyethylene (50) sorbitol hexaoleate).

In some aspects, the nonionic surfactant component may comprise an organosilicone surfactant. Non-limiting examples of organosilicone surfactants within the scope of the present disclosure include: polyether siloxanes (e.g., Break Thru® OE441); polyether trisiloxanes (e.g., Break Thru® 5240, Break Thru® S233); polyoxyethylene dimethylsiloxanes (e.g., Dyne-Amic® (a mixture with methylated seed oil)); polyoxyethylene methylpolysiloxanes (e.g., KF-640 manufactured by Shin-Etsu Chemical Co., Ltd.); polyalkylene oxide-modified polymethylsiloxane (e.g., Kinetic manufactured by Helena Chemical); polyoxyethylene propylheptamethyltrisiloxanes (e.g., Masil® SF19); polyether-modified polysiloxanes (e.g., Quark (a mixture with an alkyl phenol ethoxylate)); hydroxypropyl heptamethyltrisiloxanes (e.g., Silflow® (a mixture with ethoxylated acetate, polyethylene glycol monoallyl ether acetate and polyethylene glycol diacetate); polyalkylene oxide-modified heptamethyltrisiloxanes (e.g., Silwet® L77); polyether/polymethylsiloxane copolymers (e.g., Syl-Coat®); polyoxyethylene-modified polydimethylsiloxanes (e.g., Xiameter®); polyoxyalkylene oxypropylheptamethyltrisiloxanes; siloxane/polyalkylene oxide copolymers (e.g., Vestis™ (a mixture with polyalkylene oxide)). In some aspects, the nonionic surfactant the organosilicone surfactant is a polyether trisiloxane such as, for instance, Break Thru® S240 (a mixture of a polyether trisiloxane and an alcohol ethoxylate (CAS 9043-30-5)), Break Thru® 5321, Break Thru® 5200, Break Thru® S279, Break Thru® 5301, Break Thru® OE 441, Break Thru® S278, Break Thru® S243, Break Thru® S233, Break Thru® SD260, Silwet® L-77, Silwet® 408, Silwet® HS 429, Silwet® HS 312, Silwet® Y-12808, Silwet® L-7607, Silwet® L-7602, Silwet® L-7210, Silwet® L-7002, Silwet® L-720, and Silwet® L-7200, Sylgard® 309, and Silibase® 2848, and combinations thereof. In some aspects, the organosilicone surfactant is Break Thru® 5240. In some aspects, the organosilicone surfactant is Silwet® HS 312.

In some aspects, the nonionic surfactant component may comprise at least one alcohol alkoxylate surfactant, at least one alkylphenol alkoxylate surfactant, at least seed oil alkoxylate surfactant (e.g., Ecosurf® SA-4, Ecosurf® SA-7, Ecosurf® SA-9, and Ecosurf® SA-15), at least one alkylamine alkoxylate surfactant, at least one tallow amine alkoxylate surfactant, at last one fatty acid alkoxylate surfactant, and combinations thereof.

In some aspects, the alkoxylates may be end capped. Alcohol alkoxylates generally comprise a hydrophobic alkyl chain attached by an ether linkage to a hydrophilic alkoxy chain and have the general formula R—(OC₂₋₄)ₙ—OH. R may be C₆₋₁₈ straight or branched chain alkyl. The alkoxy moiety (OC₂₋₄) may be ethoxy, n-propyl, i-propyl, n-butyl, i-butyl or tert-butyl. In some aspects, the alkoxy moiety may be a block co-polymer of a polymeric ethoxy and polymeric propoxy or polymeric butoxy, and n may suitably be an integer of from 2 to 100. Suitable alcohol alkoxylates include linear alcohol alkoxylates, branched alcohol alkoxylates, secondary alcohol alkoxylates, and mixtures thereof. Non-limiting examples of alcohol alkoxylates include: Plurafac® SL-42 (C₆₋₁₀—(PO)₃(EO)₆); Plurafac® SL-62 (C₆₋₁₀—(PO)₃(EO)₈); Lutensol® XL series of the general structure C₁₀—(PO)ₐ(EO)_{b} where a is 1.0 to 1.5 and b is 4 to 14, including without limitation Lutensol® XL-40, Lutensol® XL-50, Lutensol® XL-60, Lutensol® XL-70, Lutensol® XL-79, Lutensol® XL-80, Lutensol® XL-89, Lutensol® XL-90, Lutensol® XL-99, Lutensol® XL-100, and Lutensol® XL-140; Ecosurf® EH series of the general structure 2-ethyl hexyl (PO)ₘ(EO)ₙ including Ecosurf® EH-3, Ecosurf® EH-6, and Ecosurf® EH-9; Ecosurf® SA series including Ecosurf® SA-4 (C₆₋₁₂—(PO)₃₋₄(EO)₄), Ecosurf® SA-7 (C₆₋₁₂—(PO)₃₋₄(EO)₇, and Ecosurf® SA-9 (C₆₋₁₂—(PO)₃₋₄(EO)₉); Tergitol® 15-S-3, Tergitol® 15-S-5, Tergitol® 15-S-7, Tergitol® 15-S-9, Tergitol® 15-S-12, Tergitol® 15-S-15, Tergitol® 15-S-20, Tergitol® 15-S-30, and Tergitol® 15-S-40; Tergitol® L-61, Tergitol® L-62, Tergitol® L-64, Tergitol® L-81, and Tergitol® L-101; Tergitol® TMN-3, Tergitol® TMN-6, and Tergitol® TMN-10), and combinations thereof. In some aspects, the alcohol alkoxylate is Lutensol® XL 50. In some aspects, the alcohol alkoxylate is Ecosurf® EH-6. In some aspects, the alcohol alkoxylate is Tergitol® 15-S-7.

In some aspects, the nonionic surfactant component may comprise at least one polymeric surfactant. Polymeric surfactants fall into several categories including, but not limited to, block copolymers, random copolymers, graft copolymer and star polymers. Non-limiting examples of polymer monomeric units include ethylene oxide, propylene oxide, acrylic, styrene, methacrylic, hydroxystearate, and ester (e.g., alkyd). Examples include, without limitation, EO/PO block copolymers, acrylic/styrene copolymers, methacrylic copolymers, poly hydroxystearate derivatives, alkyd PEG resin derivatives, and combinations thereof. Non-limiting examples of random copolymers include Atlox® 4914 (an alkyd-PEG random copolymer) and Hypermer® A70 and Hypermer® A394 (polyoxyalkylene modified random polyesters). Non-limiting examples of block copolymers include Atlox®4912 (a block copolymer having an A-B-A configuration based on 12 poly-hydroxysteric acid and PEG), poloxamers (triblock copolymers composed of a central hydrophobic chain of polyoxypropylene flanked by two hydrophilic chains of polyoxyethylene), Atlas™ G-5000 and Atlas™ G-5002L (butyl block copolymers), and Hypermer® B246 and Hypermer® B261 (polyoxyalkylene modified block copolymer). A non-limiting example of a graft copolymers is Atlox® 4913 (a methyl methacrylate graft copolymer backbone having PEG extending therefrom). A non-limiting example of a star shaped polymer is Atlox® 4916 (a sorbitol base reacted with EO and then further reacted with a polymerized fatty acid). In some aspects, the nonionic surfactant component comprises Atlox® 4914. In some aspects, the nonionic surfactant component comprises Cirrasol® G1086. In some aspects, the nonionic surfactant component comprises Cirrasol® G1096. In some aspects, the nonionic surfactant component comprises Break Thru® S240. In some aspects, the nonionic surfactant component comprises Silwet® HS 312. In some aspects, the nonionic surfactant component comprises Lutensol® XL 50. In some aspects, the nonionic surfactant component comprises Ecosurf® EH-6. In some aspects, the nonionic surfactant component comprises Tergitol® 15-S-7. In some aspects, the nonionic surfactant component comprises Atlas™ G-5002L. In some aspects, the nonionic surfactant component comprises Break Thru® SP 133. In some aspects, the nonionic surfactant component comprises Atlox® 4914, Cirrasol® G1096 and Break Thru® 5240. In some aspects, the nonionic surfactant component comprises Atlox® 4914, Cirrasol® G1096 and Tergitol® 15-S-7. In some aspects, the nonionic surfactant component comprises Atlox® 4914, Cirrasol® G1096 and Ecosurf® EH-6. In some aspects, the nonionic surfactant component comprises Atlox® 4914, Cirrasol® G1096 and Silwet® HS 312.

Anionic Surfactant Component

The compositions of the present disclosure may comprise one or more anionic surfactants. Non-limiting examples of anionic surfactants include: alkylaryl sulfonic acids and their salts; carboxylated alcohols; alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; sulfosuccinates and their derivatives such as dialkyl sulfosuccinate salts; and combinations thereof. Non-limiting examples of cationic counterions of the anionic surfactants in salt form may include, but are not limited to, alkali metal, alkaline-earth metal, ammonium, or (C₁₋₆) alkyl ammonium cation.

Non-limiting examples of anionic surfactants within the scope of the present disclosure include: ammonium lauryl sulfate; magnesium lauryl sulfate; sodium 2-ethyl-hexyl sulfate; sodium actyl sulfate; sodium oleyl sulfate; sodium tridecyl sulfate; triethanolamine lauryl sulfate; ammonium linear alcohol; ether sulfate ammonium nonylphenol ether sulfate; ammonium monoxynol-4-sulfate sulfo succinamates; tetrasodium N-(1,2-dicarboxyethyl)-N-octadecylsulfo-succinamate; diamyl ester of sodium sulfosuccinic acid; dihexyl ester of sodium sulfosuccinic acid; dioctyl esters of sodium sulfosuccinic acid; dihexyl ester of sodium sulfosuccinic acid; dioctyl esters of sodium sulfosuccinic acid (Stepwet® DOS 70); sodium polycarboxylate (Geropon® TA/72); sodium salt of naphthalene sulfonate condensate (Morwet® D425, D809, D390, and EFW); calcium naphthalene sulfonates (DAXAD® 19LCAD); sodium lignosulfonates and modified sodium lignosulfonates; sodium methyl oleyl taurate (Geropon® T-77); sodium dodecylbenzene sulfonate; N-oleyl N-methyl taurate; 1,4-dioctoxy-1,4-dioxo-butane-2-sulfonic acid; sodium lauryl sulphate; sodium dioctyl sulphosuccinate; polymeric fatty acid derivatives (such as Afcona® 6226, Atlox® LP1 and Decal® FD) where Atlox® LP1 is a poly(hydroxystearic) acid; C₁₀₋₁₆, 1-2.5 EO sodium lauryl ether sulfate (Agniqud® SLES-270); C₆₋₁₀, 3EO, ammonium sulfate (Witcolate® 1247H); C₆₋₁₀, 3EO, sodium sulfate (Witcolate® 7093); C₈₋₁₀ sodium sulfate (Witcolate® 7259); C₁₀₋₁₂, 5EO, ammonium sulfate (Witcolate® 1276); C₁₂₋₁₄, 3EO, ammonium sulfate (Witcolate® LES-60A); C₁₂₋₁₄, 3EO, sodium sulfate (Witcolate® LES-60C); C₁₂₋₁₅, 10EO, sodium sulfate (Witcolate® 1050); C₁₂₋₁₆ sodium sulfate (Witcolate® WAQ); nonylphenol 4EO, sodium sulfate (Witcolate® D-51-51); nonylphenol 10EO, sodium sulfate (Witcolate® D-51-53); calcium dodecylbenzenesulfonate (Rhodacal® 60 BE and 70 B); isopropylammonium dodecylbenzenesulfonate (Atlox® 3300B); sodium diisopropyl naphthalenesulfonate (Morwet® IP) and 60% calcium dodecylbenzenesulfonate in 2-ethylhexanol (Agnique® ABS 60C EH). In some aspects, the anionic surfactant is Agnique® ABS 60C EH. In some aspects, the anionic surfactant is Atlox® LP-1. In some aspects, the anionic surfactant is Rhodacal® 60 BE. In some aspects, the anionic surfactant is Stepwet® DOS 70, Stepwet® DOS 70 PG, Stepwet® DOS 70 DG, Stepwet® DOS 70EA, Stepwet® DOS 64, Stepwet® DOS 60 ROE, Stepwet® DOS 60 OE, or a combination thereof.

In some aspects of the present disclosure, the surfactant component can comprise a mixture of at least one nonionic surfactant and at least one anionic surfactant.

Other Surfactants

In some aspects of the disclosure, the surfactant component may optionally comprise at least one cationic surfactant. Non-limiting examples of cationic surfactants include: amides and ethoxylated amides; amines (such as N-alkyl propanediamines, tripropylenetriamines and dipropylenetetramines); ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquatemary salts; amine oxides such as alkyldimethylamine oxides and bis-(2-hydroxyethyl)-alkylamine oxides; and combinations thereof.

In some aspects of the disclosure, the surfactant component may optionally comprise at least one zwitterionic (ampholytic) surfactant. Non-limiting examples of Zwitterionic (amphoteric) surfactants include betaines, N-alkyl glycines, N-alkyl propionic acids, N-alkylaminobutyric acids, N-alkyliminodipropionic acids, N-hydroxyethyl-N-alkylamidopropyl glycines, N-alkyl taurines, N-alkyl sarcosines, 2-alkylaminopropionic acids, alkylaminoacetic acids containing a C₈₋₁₈ alkyl group, and combinations thereof.

The total surfactant content in the concentrate compositions of the present disclosure may suitably be about 5 wt. %, about 10 wt. %, about 15 wt. %, about 20 wt. %, about 25 wt. %, about 30 wt. %, about 35 wt. %, about 40 wt. %, about 50 wt. %, about 60 wt. %, or about 65 wt. %, and ranges constructed therefrom, such as from about 5 wt. % to about 65 wt. %, from about 5 wt. % to about 40 wt. %, from about 5 wt. % to about 35 wt. %, from about 10 wt. % to about 35 wt. %, from about 5 wt. % to about 35 wt. %, from about 15 wt. % to about 35 wt. %, from about 20 wt. % to about 30 wt. %, from about 20 wt. % to about 25 wt. %. The weight ratio of surfactant to diamide insecticide is suitably about 10:1, about 7.5:1 about 5:1, about 2.5:1, about 2:1 about 1.5:1, about 1.25:1, about 1.1:1, about 1:1, about 1:1.1, about 1:1.25, about 1:1.5, about 1:2 about 1:2.5, about 1:5 about 1:7.5 or about 1:10, and ranges constructed therefrom, such as from about 10:1 to about 1:10, from about 5:1 to about 1:5, from about 2.5:1 to about 1:2.5, from about 1.1:1 to about 1:1.1, from about 1:1 to about 1:1.25, from about 1:1 to about 1:1.2, from about 1:1 to about 1:1.5, or from about 1:1 to about 1:1.1. The weight ratio of surfactant to phosphate ester is suitably about 20:1, about 10:1, about 5:1, 2.5:1, about 1:1, about 1:1.5, about 1:2, about 1:2.5, about 1:5, about 1:10, about: 1:15, or 1:20, and ranges constructed therefrom, such as from about 20:1 to about 1:20, from about 10:1 to about 1:10, from about 5:1 to about 1:5, from about 2.5:1 to about 1:2.5, from about 1:1 to about 1:2.5, or from about 1:1.5 to about 1:2.5. In some particular such aspects, the diamide insecticide is chlorantraniliprole.

In aspects where the surfactant component comprises one or more nonionic surfactant and one or more anionic surfactants, the weight ratio of total nonionic surfactant to total anionic surfactant is suitably about 5:1, about 4:1, about 3.5:1, about 3.25:1, about 3:1, about 2.75:1, about 2.5:1, about 2.25:1, about 2:1, about 1.75:1, about 1.5:1, about 1.25:1, or about 1:1, and ranges constructed therefrom, such as from about 5:1 to about 1:1, from about 3.5:1 to about 1:1, from about 3.5:1 to about 1.5:1, from about 3.25:1 to about 1.75:1, from about 3:1 to about 1.75:1, from about 2.75:1 to about 1.75:1, or from about 2.75:1 to about 1.5:1. In such aspects, the total nonionic surfactant content in the concentrate compositions is suitably about 2 wt. %, about 5 wt. %, about 10 wt. %, about 12.5 wt. %, about 15 wt. %, about 17.5 wt. %, about 20 wt. %, about 22.5 wt. %, about 25 wt. %, about 30 wt. %, or about 35 wt. %, and ranges constructed therefrom, such as from about 2 wt. % to about 35 wt. %, from about 5 wt. % to about 30 wt. %, from about 10 wt. % to about 25 wt. %, from about 12.5 wt. % to about 20 wt. %, or from about 12.5 wt. % to about 17.5 wt. %. In such aspects, the total anionic surfactant content in the concentrate compositions is suitably about 2 wt. %, about 2.5 wt. %, about 5 wt. %, about 6 wt. %, about 7 wt. %, about 8 wt. %, about 9 wt. %, about 10 wt. %, about 12.5 wt. %, about 15 wt. %, about 20 wt. %, or about 25 wt. %, and ranges constructed therefrom, such as from about 2 wt. % to about 25 wt. %, from about 2.5 wt. % to about 20 wt. %, from about 2.5 wt. % to about 15 wt. %, from about 2.5 wt. % to about 10 wt. %, or from about 5 wt. % to about 10 wt. %. In some particular such aspects, the diamide insecticide is chlorantraniliprole.

In some particular aspects where the diamide insecticide is cyantraniliprole, the total surfactant content in concentrate compositions may optionally be about 10 wt. %, about 20 wt. %, about 30 wt. %, about 40 wt. %, about 50 wt. %, about 60 wt. %, or about 65 wt. %, and ranges constructed therefrom, such as from about 10 wt. % to about 65 wt. %, from about 10 wt. % to about 30 wt. %, from about 15 wt. % to about 60 wt. %, from about 20 wt. % to about 55 wt. %, from about 20 wt. % to about 40 wt. %, or from about 40 wt. % to about 65 wt. %. In such aspects, the surfactant component may optionally comprise at least one nonionic surfactant and at least one anionic surfactant. In such aspects, the weight ratio of total nonionic surfactant to total anionic surfactant may optionally be about 10:1, about 7.5:1, about 5:1, about 2.5:1, about 1.25:1 or about 1:1, and ranges constructed therefrom, such as from about 10:1 to about 1:1, from about 7.5:1 to about 1.25:1, or from about 5:1 to about 2.5:1. In such aspects, the total nonionic surfactant content in the concentrate compositions may optionally be about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, or about 60 wt. %, and ranges constructed therefrom, such as from about 5 wt. % to about 60 wt. %, from about 10 wt. % to about 60 wt. %, from about 15 wt. % to about 55 wt. %, from about 15 wt. % to about 35 wt. %, or from about 15 wt. % to about 30 wt. %. In such aspects, the total anionic surfactant content in the concentrate compositions my optionally be about 2 wt. %, about 5 wt. %, about 10 wt. %, about 15 wt. %, or about 20 wt. %, and ranges constructed therefrom, such as from about 2 wt. % to about 20 wt. %, or from about 4 wt. % to about 15 wt. %.

In any of the various oil dispersion concentrate aspects of the present disclosure, the concentrates may further optionally comprise an oil component as described herein at a concentration of about 5 wt. %, about 10 wt. %, about 15 wt. %, about 20 wt. %, about 25 wt. %, about 30 wt. %, about 35 wt. %, about 40 wt. %, about 45 wt. %, or about 50 wt. %, and ranges constructed therefrom, such as from about 5 wt. % to about 50 wt. %, from about 5 wt. % to about 40 wt. %, from about 5 wt. % to about 20 wt. %, from about 10 wt. % to about 50 wt. %, from about 10 wt. % to about 40 wt. %, from about 10 wt. % to about 30 wt. %, from about 10 wt. % to about 20 wt. %, or from about 25 wt. % to about 50 wt. %. In aspects including oil, the total surfactant and oil content may optionally be about 20 wt. %, about 25 wt. %, about 30 wt. %, about 40 wt. %, about 50 wt. %, about 60 wt. %, about 70 wt. % or about 75 wt. %, and ranges constructed therefrom, such as from about 20 wt. % to about 75 wt. %, from about 25 wt. % to about 65 wt. %, or from about 25 wt. % to about 50 wt. %.

Other Pest Control Agents

The compositions of the present disclosure may optionally include one or more pest control agents selected from insecticides, herbicides, bactericides, nematicides, and fungicides. General references for these pest control agents (i.e. insecticides, fungicides, nematocides, acaricides, herbicides and biological agents) include The Pesticide Manual, 13th Edition, C. D. S. Tomlin, Ed., British Crop Protection Council, Farnham, Surrey, U. K., 2003 and The BioPesticide Manual, 2^{nd} Edition, L. G. Copping, Ed., British Crop Protection Council, Farnham, Surrey, U. K., 2001.

Non-limiting examples of insecticides include abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos-methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cycloprothrin, cycloxaprid ((5S,8R)-1-[(6-chloro-3-pyridinyl)methyl]-2,3,5,6,7,8-hexahydro-9-nitro-5,8-Epoxy-1H-imidazo[1,2-ax]azepine), cyenopyrafen, cyflumetofen, cyfluthrin, beta-cyfluthrin, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy)phenoxy]-4-quinolinyl methyl carbonate), flonicamid, fluazaindolizine, flucythrinate, flufenerim, flufenoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, tau-fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, oxamyl, oxazosulfyl, parathion, parathion-methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ⁴-sulfanylidene]cyanamide), tebufenozide, tebufenpyrad, teflubenzuron, tefluthrin, kappa-tefluthrin, terbufos, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entomopathogenic fungi, can combinations thereof.

Non-limiting examples of fungicides include fungicides such as acibenzolar-S-methyl, aldimorph, ametoctradin, aminopyrifen, amisulbrom, anilazine, azaconazole, azoxystrobin, benalaxyl (including benalaxyl-M), benodanil, benomyl, benthiavalicarb (including benthiavalicarb-isopropyl), benzovindiflupyr, bethoxazin, binapacryl, biphenyl, bitertanol, bixafen, blasticidin-S, boscalid, bromuconazole, bupirimate, buthiobate, carboxin, carpropamid, captafol, captan, carbendazim, chloroneb, chlorothalonil, chlozolinate, copper hydroxide, copper oxychloride, copper sulfate, coumoxystrobin, cyazofamid, cyflufenamid, cymoxanil, cyproconazole, cyprodinil, dichlobentiazox, dichlofluanid, diclocymet, diclomezine, dicloran, diethofencarb, difenoconazole, diflumetorim, dimethirimol, dimethomorph, dimoxystrobin, diniconazole (including diniconazole-M), dinocap, dipymetitrone, dithianon, dithiolanes, dodemorph, dodine, econazole, etaconazole, edifenphos, enoxastrobin (also known as enestroburin), epoxiconazole, ethaboxam, ethirimol, etridiazole, famoxadone, fenamidone, fenaminstrobin, fenarimol, fenbuconazole, fenfuram, fenhexamide, fenoxanil, fenpiclonil, fenpicoxamid, fenpropidin, fenpropimorph, fenpyrazamine, fentin acetate, fentin hydroxide, ferbam, ferimzone, flometoquin, florylpicoxamid, fluopimomide, fluazinam, fludioxonil, flufenoxystrobin, fluindapyr, flumorph, fluopicolide, fluopyram, fluoxapiprolin, fluoxastrobin, fluquinconazole, flusilazole, flusulfamide, flutianil, flutolanil, flutriafol, fluxapyroxad, folpet, fthalide (also known as phthalide), fuberidazole, furalaxyl, furametpyr, hexaconazole, hymexazole, guazatine, imazalil, imibenconazole, iminoctadine albesilate, iminoctadine triacetate, inpyrfluxam, iodicarb, ipconazole, ipfentrifluconazole, ipflufenoquin, isofetamid, iprobenfos, iprodione, iprovalicarb, isoflucypram, isoprothiolane, isopyrazam, isotianil, kasugamycin, kresoxim-methyl, lancotrione, mancozeb, mandipropamid, mandestrobin, maneb, mapanipyrin, mefentrifluconazole, mepronil, meptyldinocap, metalaxyl (including metalaxyl-M/mefenoxam), metconazole, methasulfocarb, metiram, metominostrobin, metyltetraprole, metrafenone, myclobutanil, naftitine, neo-asozin (ferric methanearsonate), nuarimol, octhilinone, ofurace, orysastrobin, oxadixyl, oxathiapiprolin, oxolinic acid, oxpoconazole, oxycarboxin, oxytetracycline, penconazole, pencycuron, penflufen, penthiopyrad, perfurazoate, phosphorous acid (including salts thereof, e.g., fosetyl-aluminm), picoxystrobin, piperalin, polyoxin, probenazole, prochloraz, procymidone, propamocarb, propiconazole, propineb, proquinazid, prothiocarb, prothioconazole, pydiflumetofen (Adepidyn®), pyraclostrobin, pyrametostrobin, pyrapropoyne, pyraoxystrobin, pyraziflumid, pyrazophos, pyribencarb, pyributacarb, pyridachlometyl, pyrifenox, pyriofenone, perisoxazole, pyrimethanil, pyrifenox, pyrrolnitrin, pyroquilon, quinconazole, quinmethionate, quinofumelin, quinoxyfen, quintozene, silthiofam, sedaxane, simeconazole, spiroxamine, streptomycin, sulfur, tebuconazole, tebufloquin, teclofthalam, tecloftalam, tecnazene, terbinafine, tetraconazole, thiabendazole, thifluzamide, thiophanate, thiophanate-methyl, thiram, tiadinil, tolclofos-methyl, tolprocarb, tolyfluanid, triadimefon, triadimenol, triarimol, triazoxide, tribasic copper sulfate, triclopyricarb, tridemorph, trifloxystrobin, triflumizole, trimoprhamide tricyclazole, trifloxystrobin, triforine, triticonazole, uniconazole, validamycin, valifenalate (also known as valifenal), vinclozolin, zineb, ziram, zoxamide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, and combinations thereof.

Non-limiting examples of nematocides include fluopyram, spirotetramat, thiodicarb, fosthiazate, abamectin, iprodione, fluensulfone, dimethyl disulfide, tioxazafen, 1,3-dichloropropene (1,3-D), metam (sodium and potassium), dazomet, chloropicrin, fenamiphos, ethoprophos, cadusaphos, terbufos, imicyafos, oxamyl, carbofuran, tioxazafen, Bacillus firmus, Pasteuria nishizawae, and combinations thereof. A non-limiting example of a bactericide is streptomycin. Non-limiting examples of acaricides include amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad, and combinations thereof.

Diluents

The compositions of the present disclosure may optionally comprise one or more diluents or solvents. Non-limiting examples of suitable such diluents include water, N,N-dimethylalkanamides (e.g., N,N dimethylformamide), limonene, dimethyl sulfoxide, N alkylpyrrolidones (e.g., N methylpyrrolidinone), alkyl phosphates (e.g., triethylphosphate), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2 heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters alkyl and aryl benzoates, γ-butyrolactone, and alcohols, which can be linear, branched, saturated or unsaturated, such as methanol, ethanol, n-propanol, i-propanol, n-butanol, i-butanol, n-hexanol, 2-ethylhexanol, n-octanol, decanol, i-decyl alcohol, i-octadecanol, cetyl alcohol, lauryl alcohol, tridecyl alcohol, oleyl alcohol, cyclohexanol, tetrahydrofurfuryl alcohol, diacetone alcohol, cresol, benzyl alcohol, and combinations thereof. Diluents also include glycerol esters of saturated and unsaturated fatty acids (typically C₆₋₂₂), such as plant seed and fruit oils e.g., oils of olive, castor, linseed, sesame, corn (maize), peanut, sunflower, grapeseed, safflower, cottonseed, soybean, rapeseed (canola) (e.g., Codacide® Oil containing rapeseed oil and emulsifiers), coconut and palm kernel oils, animal-sourced fats (e.g., beef tallow, pork tallow, lard, cod liver oil, fish oil), and mixtures thereof. Diluents also include alkylated fatty acids (e.g., methylated, ethylated, butylated) wherein the fatty acids may be obtained by hydrolysis of glycerol esters from plant and animal sources, and can be purified by distillation. In some aspects, the diluent comprises an alcohol. In some such aspects, the diluent comprises 2-ethylhexanol. In some aspects, the diluent comprises water. In some aspects, the diluent comprises canola oil. In some aspects, the diluent comprises an alcohol and water. In any of the various diluent aspects, the total diluent content (when present) is about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, or about 10 wt. %, and ranges constructed therefrom, such as from about 0.5 wt. % to about 10 wt. %, from about 2 wt. % to about 8 wt. %, from about 2 wt. % to about 6 wt. %, or about 3 wt. % to about 5 wt. %. The total water content of the concentrate concentrations of the present disclosure may be 0 wt. %, about 1 wt. %, about 2 wt. %, about 3 wt. %, about 4 wt. %, about 5 wt. %, about 6 wt. %, about 7 wt. %, about 8 wt. %, about 9 wt. %, or about 10 wt. %,

Phytophagous Insects

Phytophagous insects refers to invertebrate pests causing injury to plants by feeding upon them, such as by eating foliage, stem, leaf, fruit or seed tissue or by sucking the vascular juices of plants. Leaf feeders may be external (exophytic) or they may mine the tissues, sometimes even specializing on a particular cell type. There are phytophagous insect species in the majority of insect orders, including Hemiptera, Thysanoptera, Orthoptera, Lepidoptera, Coleoptera, Heteroptera, Hymenoptera, and Diptera.

Examples of agronomic or nonagronomic invertebrate pests include eggs, larvae and adults of the order Lepidoptera, such as armyworms, cutworms, loopers, and heliothines in the family Noctuidae (e.g., pink stem borer (Sesamia inferens Walker), corn stalk borer (Sesamia nonagrioides Lefebvre), southern armyworm (Spodoptera eridania Cramer), fall armyworm (Spodoptera frugiperda J. E. Smith), beet armyworm (Spodoptera exigua Hübner), cotton leafworm (Spodoptera littoralis Boisduval), yellowstriped armyworm (Spodoptera ornithogalli Guenée), black cutworm (Agrotis ipsilon Hufnagel), velvetbean caterpillar (Anticarsia gemmatalis Hübner), green fruitworm (Lithophane antennata Walker), cabbage armyworm (Barathra brassicae Linnaeus), soybean looper (Pseudoplusia includens Walker), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworms (Pyralidae: Crambinae) such as sod worm (Herpetogramma licarsisalis Walker), sugarcane stem borer (Chilo infuscatellus Snellen), tomato small borer (Neoleucinodes elegantalis Guenée), green leafroller (Cnaphalocrocis medinalis), grape leaffolder (Desmia funeralis Hübner), melon worm (Diaphania nitidalis Stoll), cabbage center grub (Helluala hydralis Guenée), yellow stem borer (Scirpophaga incertulas Walker), early shoot borer (Scirpophaga infuscatellus Snellen), white stem borer (Scirpophaga innotata Walker), top shoot borer (Scirpophaga nivella Fabricius), dark-headed rice borer (Chilo polychrysus Meyrick), striped riceborer (Chilo suppressalis Walker), cabbage cluster caterpillar (Crocidolomia binotalis English)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck), citrus false codling moth (Cryptophlebia leucotreta Meyrick), citrus borer (Ecdytolopha aurantiana Lima), redbanded leafroller (Argyrotaenia velutinana Walker), obliquebanded leafroller (Choristoneura rosaceana Harris), light brown apple moth (Epiphyas postvittana Walker), European grape berry moth (Eupoecilia ambiguella Hübner), apple bud moth (Pandemis pyrusana Kearfott), omnivorous leafroller (Platynota stultana Walsingham), barred fruit-tree tortrix (Pandemis cerasana Hübner), apple brown tortrix (Pandemis heparana Denis & Schiffermüller)); and many other economically important lepidoptera (e.g., diamond back moth (Plutella xylostella Linnaeus), pink bollworm (Pectinophora gossypiella Saunders), gypsy moth (Lymantria dispar Linnaeus), peach fruit borer (Carposina niponensis Walsingham), peach twig borer (Anarsia lineatella Zeller), potato tuberworm (Phthorimaea operculella Zeller), spotted teniform leafminer (Lithocolletis blancardella Fabricius), Asiatic apple leafminer (Lithocolletis ringoniella Matsumura), rice leaffolder (Lerodea eufala Edwards), apple leafminer (Leucoptera scitella Zeller)); eggs, nymphs and adults of the order Blattodea including cockroaches from the families Blattellidae and Blattidae (e.g., oriental cockroach (Blatta orientalis Linnaeus), Asian cockroach (Blatella asahinai Mizukubo), German cockroach (Blattella germanica Linnaeus), brownbanded cockroach (Supella longipalpa Fabricius), American cockroach (Periplaneta americana Linnaeus), brown cockroach (Periplaneta brunnea Burmeister), Madeira cockroach (Leucophaea maderae Fabricius)), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); eggs, foliar feeding, fruit feeding, root feeding, seed feeding and vesicular tissue feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)), annual bluegrass weevil (Listronotus maculicollis Dietz), bluegrass billbug (Sphenophorus parvulus Gyllenhal), hunting billbug (Sphenophorus venatus vestitus), Denver billbug (Sphenophorus cicatristriatus Fahraeus)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera LeConte)); chafers and other beetles from the family Scarabaeidae (e.g., Japanese beetle (Popilia japonica Newman), oriental beetle (Anomala orientalis Waterhouse, Exomala orientalis (Waterhouse) Baraud), northern masked chafer (Cyclocephala borealis Arrow), southern masked chafer (Cyclocephala immaculata Olivier or C. lurida Bland), dung beetle and white grub (Aphodius spp.), black turfgrass ataenius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae and flour beetles from the family Tenebrionidae.

In addition, agronomic and nonagronomic pests include: eggs, adults and larvae of the order Dermaptera including earwigs from the family Forficulidae (e.g., European earwig (Forficula auricularia Linnaeus), black earwig (Chelisoches morio Fabricius)); eggs, immatures, adults and nymphs of the orders Hemiptera and Homoptera such as, plant bugs from the family Miridae, cicadas from the family Cicadidae, leafhoppers (e.g. Empoasca spp.) from the family Cicadellidae, potato leafhoppers, bed bugs (e.g., Cimex lectularius Linnaeus) from the family Cimicidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, chinch bugs (e.g., hairy chinch bug (Blissus leucopterus hirtus Montandon) and southern chinch bug (Blissus insularis Barber)) and other seed bugs from the family Lygaeidae, spittlebugs from the family Cercopidae squash bugs from the family Coreidae, and red bugs and cotton stainers from the family Pyrrhocoridae.

Agronomic and nonagronomic pests also include: eggs, larvae, nymphs and adults of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)); flat mites in the family Tenuipalpidae (e.g., citrus flat mite (Brevipalpus lewisi McGregor)); rust and bud mites in the family Eriophyidae and other foliar feeding mites and mites important in human and animal health, i.e. dust mites in the family Epidermoptidae, follicle mites in the family Demodicidae, grain mites in the family Glycyphagidae; ticks in the family Ixodidae, commonly known as hard ticks (e.g., deer tick (Ixodes scapularis Say), Australian paralysis tick (Ixodes holocyclus Neumann), American dog tick (Dermacentor variabilis Say), lone star tick (Amblyomma americanum Linnaeus)) and ticks in the family Argasidae, commonly known as soft ticks (e.g., relapsing fever tick (Ornithodoros turicata), common fowl tick (Argas radiatus)); scab and itch mites in the families Psoroptidae, Pyemotidae, and Sarcoptidae; eggs, adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), bush locust (Zonocerus spp.), house cricket (Acheta domesticus Linnaeus), mole crickets (e.g., tawny mole cricket (Scapteriscus vicinus Scudder) and southern mole cricket (Scapteriscus borellii Giglio-Tos)); eggs, adults and immatures of the order Diptera including leafminers (e.g., Liriomyza spp. such as serpentine vegetable leafminer (Liriomyza sativae Blanchard)), midges, fruit flies (Tephritidae), frit flies (e.g., Oscinellafrit Linnaeus), soil maggots, house flies (e.g., Musca domestica Linnaeus), lesser house flies (e.g., Fannia canicularis Linnaeus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnaeus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; eggs, adults and immatures of the order Thysanoptera including onion thrips (Thrips tabaci Lindeman), flower thrips (Frankliniella spp.), and other foliar feeding thrips; insect pests of the order Hymenoptera including ants of the Family Formicidae including the Florida carpenter ant (Camponotus floridanus Buckley), red carpenter ant (Camponotus ferrugineus Fabricius), black carpenter ant (Camponotus pennsylvanicus De Geer), white-footed ant (Technomyrmex albipes fr. Smith), big headed ants (Pheidole sp.), ghost ant (Tapinoma melanocephalum Fabricius); Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Farster) and odorous house ant (Tapinoma sessile Say). Other Hymenoptera including bees (including carpenter bees), hornets, yellow jackets, wasps, and sawflies (Neodiprion spp.; Cephus spp.); insect pests of the order Isoptera including termites in the Termitidae (e.g., Macrotermes sp., Odontotermes obesus Rambur), Kalotermitidae (e.g., Cryptotermes sp.), and Rhinotermitidae (e.g., Reticulitermes sp., Coptotermes sp., Heterotermes tenuis Hagen) families, the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus).

Examples of invertebrate pests of stored grain include larger grain borer (Prostephanus truncatus), lesser grain borer (Rhyzopertha dominica), rice weevil (Stiophilus oryzae), maize weevil (Stiophilus zeamais), cowpea weevil (Callosobruchus maculatus), red flour beetle (Tribolium castaneum), granary weevil (Stiophilus granarius), Indian meal moth (Plodia interpunctella), Mediterranean flour beetle (Ephestia kuhniella) and flat or rusty grain beetle (Cryptolestis ferrugineus).

Compositions of the present disclosure may have activity on members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e. root knot nematodes in the genus Meloidogyne, lesion nematodes in the genus Pratylenchus, stubby root nematodes in the genus Trichodorus, etc.) and animal and human health pests (i.e. all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compositions of the disclosure may have activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenée (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermuller (grape berry moth), Pectinophora gossypiella Saunders (pink bollworm), Phyllocnistis citrella Stainton (citrus leafminer), Pieris brassicae Linnaeus (large white butterfly), Pieris rapae Linnaeus (small white butterfly), Plutella xylostella Linnaeus (diamond back moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)).

Compositions of the disclosure may have significant activity on members from the order Homoptera including: Acyrthosiphon pisum Harris (pea aphid), Aphis craccivora Koch (cowpea aphid), Aphisfabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosiphum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stil (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnaeus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla).

Compositions of this disclosure also may have activity on members from the order Hemiptera including: Acrosternum hilare Say (green stink bug), Anasa tristis De Geer (squash bug), Blissus leucopterus Say (chinch bug), Cimex lectularius Linnaeus (bed bug) Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Halymorpha halys Stål (brown marmorated stink bug), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the disclosure include Thysanoptera (e.g., Frankliniella occidentalis Pergande (western flower thrips), Scirthothrips citri Moulton (citrus thrips), Sericothrips variabilis Beach (soybean thrips), and Thrips tabaci Lindeman (onion thrips); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

In some aspects, the compositions of the disclosure are useful for controlling Western Flower Thrips (Frankliniella occidentalis). In some aspects, the compositions of the disclosure are useful for controlling potato leafhopper (Empoasca fabae). In some aspects, the compositions of the disclosure are useful for controlling cotton melon aphid (Aphis gossypii). In some aspects, the compositions of the disclosure are useful for controlling diamond backmoth (Plutella xylostella L.). In some aspects, the compositions of the disclosure are useful for controlling Silverleaf Whitefly (Bemisia argentifolii Bellows & Perring).

In cyantraniliprole aspects of the disclosure, the compositions of the disclosure are effective against Coleoptera, Chrysomelidae, Cerotoma trifurcata bean leaf beetle, Chaetocnema concinna beet flea beetle, Epilachna varivestis Mexican bean beetle, Epitrix cucumeris potato flea beetle, Leptinotarsa decemlineata Colorado potato beetle, Oulema melanopus cereal leaf beetle, Oulema oryzae rice leaf beetle, Phyllotreta cruciiferae cabbage flea beetle, Phyllotreta striolata striped flea beetle, Psylliodes spp. flea beetles, Curculionidae, Anthonomus eugenii pepper weevil, Ceutorhynchus napi cabbage stem weevil, Ceutorhynchus quadridens cabbage seed-stalk curculio, Conotrachelus nenuphar plum curculio, Hypera bruneipennis Egyptian alfalfa weevil, Hypera postica alfalfa weevil, Lissorhoptrus oryzophilus rice water weevil, Nitidulidae, Meligethes aeneus pollen beetle, blossom beetle, Scarabaeidae, Cotinis nitida green June beetle, Phyllophaga spp. June beetles, grubs, Popillia japonica Japanese beetle, Diptera, Agromyzidae, Liromyza chinensis stone leek leafminer, Liromyza huidobrensis pea leafminer, Liriomyza sativae serpentine/vegetable leafminer, Liromyza trifolii American serpentine leafminer, Anthomyiidae, Delia antiqua onion fly, Delia platura seedcorn maggot, Muscidae, Atherigona oryzae rice seedling fly, Psilidae, Psila rosae carrot fly, Tephritidae, Anastrepha fraterculus South American fruit fly, Anastrepha ludens Mexican fruit fly, Anasterpha striata guava fruit fly, Bactrocera cucurbitae melon fly, Bactrocera dorsalis oriental fruit fly, Bactrocera oleae olive fly, Ceratitis capitata Mediterranean fruit fly, Chromatomyia horticola garden pea leafminer, Rhagoletis cerasi cherry fruit fly, Rhagoletis cingulata cherry fruit fly, Rhagoletis indifferens western cherry fruit fly, Rhagoletis pomonella apple maggot, Hemiptera, Aleyrodidae, Aleyrodes proletella cabbage whitefly, Bemisia tabaci sweet potato whitefly, cotton whitefly, Dialeurodes citri citrus whitefly, Trialeurodes vaporariorum, greenhouse whitefly, Aphididae, Acyrthosiphon pisum pea aphid, Aphis craccivora cowpea aphid, Aphis fabae black bean aphid, Aphis glycines soybean aphid, Aphis gossypii cotton aphid, melon aphid, Aphis nasturtii buckthorn aphid, Aphis pomi green apple aphid, Aphis spiraceola spirea aphid, Aulacorthum solani foxglove aphid, Brachycaudus persicae black peach aphid, Brevicoryne brassicae cabbage aphid, Chromaphis juglandicola European walnut aphid, Dysaphis plantaginea rosy apple aphid, Hyalopterus pruni mealy plum aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Rhopalosiphum nymphaeae plum aphid, Schizaphis graminum greenbug, Sitobion avenae English grain aphid, Therioaphis maculata spotted alfalfa aphid, Toxoptera citricida brown citrus aphid, oriental citrus aphid, Cicadellidae, Empoasca fabae leafhopper/jassid complex, Empoasca vitis green frogfly, Hortensia similis common green leafhopper, Idioscopus spp. mango leafhopper, Jacobiasca lybica cotton jassid, Nephotettix spp. rice green leafhopper complex, Typhlocyba rosae rose leafhopper, Typhlocyba pomaria white apple leafhopper, Coreidae Leptocorisa oratorius rice bug, rice ear bug, paddy bug, Delphacidae, Nilaparvata lugens rice brown planthopper, Diaspididae, Aonidiella aurantii citrus scale, Flatidae, Metcalfa pruinosa citrus flatid planthopper, Pentatomidae, Euschistus spp. brown stinkbugs, Edessa spp. stink bugs, Psyllidae, Diaphorina citri Asian citrus psyllid, Paratrioza cockerelli potato psyllid, tomato psyllid, Trioza eugeniae eugenia psyllid, lillypilly psyllid, Hymenoptera Tenthredinidae, Hoplocampa testudinea European apple sawfly, Lepidoptera, Crambidae, Scirpophaga incertulas yellow (rice) stemborer, Gelechiidae, Anarsia lineatella peach twig borer, Keiferia lycopersicella tomato pinworm, Pectinophora gossypiella pink bollworm, Tuta absoluta tomato leafminer, Gracillariidae, Gracillaria theivora tea leafroller, Phyllonorycter blancardella spotted tentiform leafminer, Phyllonorycter coryfoliella nut leaf blister moth, Phyllonorycter crataegella apple blotch leafminer, Phyllonorycter ringoniella apple leafminer, Phyllonorycter elmaella western tentiform leafminer, Hesperiidae, Borbo cinara rice leafroller, Lyonetiidae, Leucoptera coffeella white coffee leafminer, Leucoptera scitella pear leaf blister moth, Lyonetia clerkella peach, leaf miner, Noctuidae, Agrotis segetum common cutworm, Alabama argillacea cotton leafworn, Autographa californica alfalfa looper, Barathra brassicae cabbage armyworm, Chrysodeixis chalcites green garden looper, Chrysodeixis eriosoma green semi-looper, Earias insulana Egyptian bollworm, Earias vittella northern rough bollworm, Feltia subterranea granulate cutworm, Helicoverpa armigera American bollworm, cotton bollworm, Helicoverpa punctigera climbing cutworm, Heliothis virescens tobacco budworm, Helicoverpa zea corn earworm, Prodenia ornithogalli yellow-striped armyworm, Pseudaletia unipuncta true armyworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistidae, Phyllocnistis citrella citrus leafminer, Pieridae, Colias eurytheme alfalfa caterpillar, Leptophobia aripa green-eyed white, Pieris brassicae cabbage butterfly, large white, Pieris rapae imported cabbage worm, cabbage white, Plutellidae, Plutella xylostella diamondback moth, Pyralidae, Chilo suppressalis Asiatic rice stemborer, Cnaphalocerus medinalis rice leaffolder, Crocidolomia binotalis cabbage caterpillar, Desmia funeralis grape leaffolder, Diaphania indica cotton caterpillar, Diaphania nitidaltis melonworm, Hellula hydralis cabbage center grub, Hellula undalis cabbage webworm, Lerodea eufala rice leaffolder, Leucinodes orbonalis brinjal fruit borer, Maruca testulalis bean pod borer, Neoleucinodes elegantalis small tomato borer, Nymphula depunctalis rice caseworm, Ostrinia furnicalis Asian corn borer, Ostrinia nubilalis European corn borer, Sphingidae, Manduca sexta tomato hornworm, tobacco hornworm, Smerinthus spp. sphinx moths, Tortricidae, Adoxophyes orana summer fruit tortrix, Argyrotaenia pulchellana grape tortrix, Argyrotaenia velutinana red-banded leafroller, Choristoneura rosaceana oblique-banded leafroller, Eupoecilia ambiguella grape berry moth, Cydia pomonella codling moth, Cydia prunivora lesser apple worm, Grapholita molesta oriental fruit moth, Lobesia botrana grape vine moth, Pandemis heparana apple brown tortrix, Pandemis limitata three-lined leaf roller, Paramyelois transitella navel orangeworm, Platynota idaeusalis tufted apple bud moth, Platynota stultana omnivorus leafroller, Thysanoptera, Thripidae, Enneothrips flavens, Frankliniella fusca tobacco thrips, Frankliniella intonsa European flower thrips, Frankliniella occidentalis western flower thrips, Frankliniella schultzei common blossom thrips, Frankliniella tritici eastern flower thrips, Megalurothrips sjostedti cowpea thrips, Megalurothrips usitatus bean blossom thrips, Scirthothrips citri citrus thrips, Scirthothrips dorsalis yellow tea thrips, chilli thrips, Sericothrips variabilis soybean thrips, Stenchaetothrips biformis oriental rice thrips, Thrips arizonensis cotton thrips, Thrips meridionalis peach thrips, Thrips palmi melon thrips, and Thrips tabaci onion thrips, common cotton thrips.

In some cyantraniliprole aspects, of the disclosure, the compositions of the disclosure are effective against Leptinotarsa decemlineata Colorado potato beetle, Oulema oryzae rice leaf beetle, Phyllotreta cruciiferae cabbage flea beetle, Phyllotreta striolata striped flea beetle, Psylliodes spp. flea beetles, Anthonomus eugenii pepper weevil, Conotrachelus nenuphar plum curculio, Lissorhoptrus oryzophilus rice water weevil, Meligethes aeneus pollen beetle, blossom beetle, Liromyza chinensis stone leek leafminer, Liromyza huidobrensis pea leafminer, Liriomyza sativae serpentine/vegetable leafminer, Liromyza trifolii American serpentine leafminer, Delia antiqua onion fly, Delia platura seedcorn maggot, Psila rosae carrot fly, Bactrocera dorsalis oriental fruit fly, Bactrocera oleae olive fly, Ceratitis capitata Mediterranean fruit fly, Rhagoletis indifferens western cherry fruit fly, Rhagoletis pomonella apple maggot, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis fabae black bean aphid, Aphis gossypii cotton aphid, melon aphid, Aphis pomi green apple aphid, Aphis spiraceola spirea aphid, Aulacorthum solani foxglove aphid, Brevicoryne brassicae cabbage aphid, Dysaphis plantaginea rosy apple aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Schizaphis graminum greenbug, Sitobion avenae English grain aphid, Toxoptera citricida brown citrus aphid, oriental citrus aphid, Empoasca vitis green frogfly, Idioscopus spp. mango leafhopper, Nilaparvata lugens rice brown planthopper, Aonidiella aurantii citrus scale, Euschistus spp. brown stinkbugs, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistis citrella citrus leafminer, Pieris brassicae cabbage butterfly, large white, Pieris rapae imported cabbage worm, cabbage white, Plutella xylostella diamondback moth, Chilo suppressalis Asiatic rice stemborer, Cnaphalocerus medinalis rice leaffolder, Leucinodes orbonalis brinjal fruit borer, Ostrinia furnicalis Asian corn borer, Ostrinia nubilalis European corn borer, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella intonsa European flower thrips, Frankliniella occidentalis western flower thrips, Scirthothrips citri citrus thrips, Scirthothrips dorsalis yellow tea thrips, chilli thrips, Thrips palmi melon thrips, and Thrips tabaci onion thrips, common cotton thrips.

In some cyantraniliprole aspects, of the disclosure, the compositions of the disclosure are effective against Conotrachelus nenuphar plum curculio, Liromyza huidobrensis pea leafminer, Liriomyza sativae serpentine/vegetable leafminer, Liromyza trifolii American serpentine leafminer, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis gossypii cotton aphid, melon aphid, Brevicoryne brassicae cabbage aphid, Dysaphis plantaginea rosy apple aphid, Myzus persicae green peach aphid, peach potato aphid, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Phyllocnistis citrella citrus leafminer, Plutella xylostella diamondback moth, Chilo suppressalis Asiatic rice stemborer, Cnaphalocerus medinalis rice leaffolder, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella occidentalis western flower thrips, Scirthothrips dorsalis yellow tea thrips, chilli thrips, Thrips palmi melon thrips, and Thrips tabaci onion thrips, common cotton thrips.

In chlorantraniliprole aspects of the disclosure, the compositions of the disclosure are effective against: Coleoptera (Chrysomelida, Leptinotarsa decemlineata Colorado potato beetle, Curculionidae, Lissorhoptrus oryzophilus rice water weevil, Listronotus maculicollis annual bluegrass weevil, Oryzophagus oryzae rice water weevil, Sphenophorus spp. Billbug, Scarabaeidae Ataenius spretulus black turfgrass ataenius, Aphodius spp. scarab beetles, Cotinis nitida green June beetle, Cyclocephala spp. masked chafers, Exomala orientalis oriental beetle grub, Maladera castanea Asiatic garden beetle, Phyllophaga spp. June beetles, Popillia japonica Japanese beetle, and Rhizotrogus majalis European chafer); Diptera (Agromyzidae, Chromatomyia horticola garden pea leafminer, and Liriomyza spp. Leafminers); Hemiptera (Aleyrodidae, Bemisia spp. Whitefly, Trialeurodes abutiloneus bandedwinged whitefly, Cicadellidae, and Typhlocyba pomaria white apple leafhopper); Isoptera (Rhinotermitidae, Heterotermes tenuis sugarcane termite, Termitidae, Microtermes obesi sugarcane termite, and Odontotermes obesus sugarcane termite); and Lepidoptera (Arctiidae, Estigmene acrea saltmarsh caterpillar, Crambidae, Achyra rantalis garden webworm, Desmia funeralis grape leaffolder, Ostrinia nubilalis European corn borer, Gelechiidae, Anarsia lineatella peach twig borer, Keiferia lycopersicella tomato pinworm, Phthorimaea operculella potato tuberworm, Tuta absoluta S. American tomato pinworm, Geometridae, Operophthera brumata winter moth, Gracilaridae, Phyllocnistis citrella citrus leafminer, Lithocolletis ringoniella apple leafminer, Phyllonorycter blancardella spotted tentiform leafminer, Lyonetidae, Leucoptera spp. (ie: malifoliella, coffeella) coffee leafminer, pear leaf blister moth, Noctuidae, Agrotis ipsilon black cutworm, Alabama argillacea cotton leafworm, Amphipyra pyramidoides humped green fruitworm, Anticarsia gemmatalis velvetbean caterpillar, Autographa gamma common silver Y moth, Barathra brassicae cabbage armyworm, Earias spp. (ie: huegeliana, insulana, vitella) rough, spiny, northern rough bollworm, Helicoverpa spp. (ie: armigera, punctigera, zea) bollworms/budworms/fruitworms, Heliothis virescens tobacco budworm, Lithophane antennata green fruitworm, Mamestra brassicae cabbage moth, Orthosia hibisci green fruitworm, Phalaenoides glycinae grape vine moth, Phytometra acuta tomato semi-looper, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieridae, Pieris spp. (ie: brassica, rapae) large white, imported cabbageworm, Plutellidae, Plutella xylostella diamondback moth, Pyralidae, Amyelois transitella navel orangeworm, Chilo spp. (ie: infuscatellus, polychrysus, suppressalis) sugarcane/rice stem borers, Cnaphalocrocis medinalis rice leafroller, Crambus spp. sod webworm, Crocidolomia binotalis cabbage cluster caterpillar, Diaphania spp. (ie: hyalinata, nitidalis) melonworm, pickleworm, Diatraea saccharalis, Brazilian sugarcane borer, Elasmopalpus lignosellus lesser stalk borer, Evergestis rimosalis cross-stripped cabbageworm, Hedylepta indicata soybean leaffolder, Hellula spp. (ie: hydralis, undalis) cabbage centre-grub, cabbage webworm, Leucinodes orbonalis eggplant shoot and fruit borer, Maruca spp. pod borer, Neoleucinodes elegantalis tomato small borer, Scirpophaga spp. sugarcane/rice stem borer, Sesamia spp. (ie: inferens, nonagrioides) pink stem borer/corn stalk borer, Sphingidae, Manduca spp. (ie: quinquemaculata, sexta) tomato/tobacco hornworm, Tortricidae, Adoxophyes orana summer fruit tortrix, Argyrotaenia spp. (ie: pulchellana, velutinana) grape tortrix, redbanded leafroller, Bonagota cranaodes Brazilian apple leafroller, Carposina spp. (ie: niponensis, sasaki) peach fruit borer, peach fruit moth, Choristoneura rosaceana obliquebanded leafroller, Cryptophlebia leucotreta false codling moth, Cydia pomonella codling moth, Ecdytolopha aurantiana citrus borer, Endopiza vitana grape berry moth, Epiphyas postvittana light brown apple moth, Eupoecilia ambiguella European grape berry moth, Grapholita molesta oriental fruit moth, Lobesia botrana European grapevine moth, Pandemis spp. (ie: cerasana, heparana, barred fruit tree tortrix, limitata, pyrusana) apple brown tortrix, three-lined leafroller, apple pandemic, Platynota spp. (ie: idaeusalis, stultana) tufted apple bud moth, omnivorous leafroller, Zygaenidae, and Harrisina spp. (ie: americana, brillians) grapeleaf/western grapeleaf skeletonizer).

In some chlorantraniliprole aspects of the disclosure, the compositions of the disclosure are effective against: Leptinotarsa decemlineata Colorado potato beetle, Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Phthorimaea operculella potato tuberworm, Tuta absoluta S. American tomato pinworm, Phyllocnistis citrella citrus leafminer, Phyllonorycter blancardella spotted tentiform leafminer, Leucoptera spp. (ie: malifoliella, coffeella) coffee leafminer, Agrotis ipsilon black cutworm, Alabama argillacea cotton leafworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieris spp. (ie: brassica, rapae) large white, imported cabbageworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Leucinodes orbonalis eggplant shoot and fruit borer, Scirpophaga spp. sugarcane/rice stem borer, Sesamia spp. (ie: inferens, nonagrioides) pink stem borer/corn stalk borer, Carposina spp. (ie: niponensis, sasaki) peach fruit borer, peach fruit moth, Choristoneura rosaceana obliquebanded leafroller, Cydia pomonella codling moth, Eupoecilia ambiguella European grape berry moth, Grapholita molesta oriental fruit moth, and Lobesia botrana European grapevine moth.

In some chlorantraniliprole aspects of the disclosure, the compositions of the disclosure are effective against: Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Tuta absoluta S. American tomato pinworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Scirpophaga spp. sugarcane/rice stem borer, Sesamia spp. (ie: inferens, nonagrioides) pink stem borer/corn stalk borer, Cydia pomonella codling moth, Grapholita molesta oriental fruit moth, and Lobesia botrana European grapevine moth.

Plants

These present compositions are thus useful for protecting agronomic field crops other non-agronomic horticultural crops and plants from phytophagous invertebrate pests. This utility includes protecting crops and other plants (i.e. both agronomic and nonagronomic) that contain genetic material introduced by genetic engineering (i.e. transgenic) or modified by mutagenesis to provide advantageous traits. Examples of such traits include tolerance to herbicides, resistance to phytophagous pests (e.g., insects, mites, aphids, spiders, nematodes, snails, plant-pathogenic fungi, bacteria and viruses), improved plant growth, increased tolerance of adverse growing conditions such as high or low temperatures, low or high soil moisture, and high salinity, increased flowering or fruiting, greater harvest yields, more rapid maturation, higher quality and/or nutritional value of the harvested product, or improved storage or process properties of the harvested products. Transgenic plants can be modified to express multiple traits. Examples of plants containing traits provided by genetic engineering or mutagenesis include varieties of corn, cotton, soybean and potato expressing an insecticidal Bacillus thuringiensis toxin such as YIELD GARD®, KNOCKOUT®, STARLINK®, BOLLGARD®, NuCOTN® and NEWLEAF®, INVICTA RR2 PRO™, and herbicide-tolerant varieties of corn, cotton, soybean and rapeseed such as ROUNDUP READY®, LIBERTY LINK®, IMI®, STS® and CLEARFIELD®, as well as crops expressing N-acetyltransferase (GAT) to provide resistance to glyphosate herbicide, or crops containing the HRA gene providing resistance to herbicides inhibiting acetolactate synthase (ALS). The present compositions may interact synergistically with traits introduced by genetic engineering or modified by mutagenesis, thus enhancing phenotypic expression or effectiveness of the traits or increasing the invertebrate pest control effectiveness of the present compounds and compositions. In particular, the present compositions may interact synergistically with the phenotypic expression of proteins or other natural products toxic to invertebrate pests to provide greater-than-additive control of these pests, i.e. produce a combined effect greater than the sum of their separate effects.

Plants within the scope of the present disclosure include crops, vegetables, fruits, trees other than fruit trees, lawn, and other uses (flowers, biofuel plants and ornamental foliage). Crops include: corn, rice, wheat, barley, rye, oat, sorghum, cotton, soybean, peanut, buckwheat, beet, rapeseed, sunflower, sugar cane, tobacco, and others known in the art. Vegetables include: solanaceous vegetables (for example, eggplant, tomato, pimento, pepper and potato); cucurbitaceous vegetables (for example, cucumber, pumpkin, zucchini, water melon, and melon); cruciferous vegetables (for example, Japanese radish, white turnip, horseradish, kohlrabi, Chinese cabbage, cabbage, leaf mustard, broccoli, and cauliflower); asteraceous vegetables (for example, burdock, crown daisy, artichoke and lettuce); liliaceous vegetables (for example, green onion, onion, garlic and asparagus); ammiaceous vegetables (for example, carrot, parsley, celery and parsnip); chenopodiaceous vegetables (for example, spinach and Swiss chard); and lamiaceous vegetables (for example, Perilla frutescens, mint and basil). Fruits include: pomaceous fruits (for example, apple, pear, Japanese pear, Chinese quince and quince); stone fleshy fruits (for example, peach, plum, nectarine, Prunus mume, cherry fruit, apricot and prune); citrus fruits (for example, Citrus unshiu, orange, lemon, lime and grapefruit); nuts (for example, chestnut, walnuts, hazelnuts, almond, pistachio, cashew nuts and macadamia nuts); berry fruits (for example, blueberry, cranberry, blackberry, strawberry, and raspberry); grape; kaki; persimmon; olive; Japanese plum; banana; coffee; date palm; coconuts; and oil palm. Trees other than fruit trees include: tea; mulberry; and other trees (for example, ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, Taxus cuspidate, elm and Japanese horse chestnut), Sweet viburnum, Podocarpus macrophyllus, Japanese cedar, Japanese cypress, croton, Japanese spindletree, and Photinia glabra). Lawn uses include: sods (for example, Zoysia japonica, Zoysia matrella); bermudagrasses; bent grasses; festucae; ryegrasses. Flower uses include: rose, carnation, chrysanthemum, Eustoma, gypsophila, gerbera, marigold, salvia, petunia, verbena, tulip, aster, gentian, lily, pansy, cyclamen, orchid, lily of the valley, lavender, stock, ornamental cabbage, primula, Poinsettia, gladiolus, Cattleya, daisy, Cymbidium and begonia. Bio-fuel plants include: jatropha, safflower, Camelina, switch grass, Miscanthus giganteus, Phalaris arundinacea, Arundo donax, kenaf, cassava, and willow.

Non-Agronomic Uses

Non-agronomic uses refer to invertebrate pest control in the areas other than fields of crop plants. Nonagronomic uses of the present compositions include control of invertebrate pests in stored grains, beans and other foodstuffs, and in textiles such as clothing and carpets. Nonagronomic uses of the present compositions also include invertebrate pest control in ornamental plants, forests, in yards, along roadsides and railroad rights of way, and on turf such as lawns, golf courses and pastures. Nonagronomic uses of the present compositions also include invertebrate pest control in houses and other buildings which may be occupied by humans and/or companion, farm, ranch, zoo or other animals. Nonagronomic uses of the present compositions also include the control of pests such as termites that can damage wood or other structural materials used in buildings.

Nonagronomic uses of the present compositions also include protecting human and animal health by controlling invertebrate pests that are parasitic or transmit infectious diseases. The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. of the present disclosure are suitable for systemic and/or non-systemic control of infestation or infection by parasites on animals. Compositions of the present disclosure are particularly suitable for combating external parasitic or disease transmitting pests. Compositions of the present disclosure are suitable for combating parasites that infest agricultural working animals, such as cattle, sheep, goats, horses, pigs, donkeys, camels, buffalos, rabbits, hens, turkeys, ducks, geese and bees; pet animals and domestic animals such as dogs, cats, pet birds and aquarium fish; as well as so-called experimental animals, such as hamsters, guinea pigs, rats and mice. By combating these parasites, fatalities and performance reduction (in terms of meat, milk, wool, skins, eggs, honey, etc.) are reduced, so that applying a composition of the present disclosure allows more economic and simple husbandry of animals.

Concentrate Compositions

The process for preparing the OD concentrate compositions of the present disclosure may comprise the following three steps.

In the first step, the diamide insecticide is dispersed in phosphate ester, optionally in the presence of a dispersant. Additional pesticides may optionally be added to the phosphate ester. In one aspect, the diamide and/or the additional pesticide can be added to a mixture of all non-biologically active agents of the composition. In accordance with the present disclosure, the phosphate ester functions as the oil phase in the concentrate compositions of the present disclosure. Additional oil, such as crop oil (e.g. methylated seed oil) or paraffinic oil (e.g. Isopar M), may optionally be added in the first step. When present, the additional oil concentration may suitably be about 2 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 60 wt %, about 70 wt %, or about 80 wt %, and ranges constructed therefrom. The dispersant may be a polymeric nonionic surfactant or a polymeric anionic surfactant as described elsewhere herein. For instance, in some aspects, the dispersant may be a nonionic random copolymer of polyolefin and polyalkylene oxide (e.g., Atlox® 4914) or an anionic polymeric carboxylic acid (e.g., Atlox® LP-1). The dispersant concentration may suitably be about 1 wt. %, about 2 wt. %, about 3 wt. %, about 4 wt. %. about 5 wt. %, about 6 wt. %, about 7 wt. %, about 8 wt. %, about 9 wt. %, about 10 wt. %, or about 11 wt %, or about 12 wt %, or about 13 wt %, or about 14 wt %, or about 15 wt %, or about 16 wt %, or about 17 wt %, or about 18 wt %, or about 19 wt %, or about 20 wt % or in a range constructed from any of those values. In one aspect, one or more dispersants may be added. When present, the additional dispersant concentration may suitably be about 1 wt. %, about 2 wt. %, about 3 wt. %, about 4 wt. %. about 5 wt. %, about 6 wt. %, about 7 wt. %, about 8 wt. %, about 9 wt. % or about 10 wt. %, or about 11 wt %, or about 12 wt %, or about 13 wt %, or about 14 wt %, or about 15 wt %, or about 16 wt %, or about 17 wt %, or about 18 wt %, or about 19 wt %, or about 20 wt %, or in a range constructed from any of those values. For instance, in some aspects, the additional dispersant may be a butyl block copolymer (e.g., Atlas® G 5002L) or an amphoteric polymeric dispersant (e.g., Atlox® 4915). The first step may be done in process equipment known to those skilled in the art, such as an overhead agitator, a high shear mixer, high shear mill (e.g., a colloid mill) or a homogenizer. One or more additives described in the third step below may optionally be added in the first step.

In an optional second step, the dispersion from step 1 may be wet milled to reduce the average median particle size D50 (50^{th} percentile of cumulative size distribution) to less than about 10 m and average particle size D90 (90^{th} percentile of cumulative size distribution) to less than about 30 m. Particle size Dx means that x % of the particles have a particle size smaller than the number indicated. Particle size can be measured by a laser diffraction instrument known to those skilled in the art. Wet milling may be done in process equipment known in the art such as ball mills or colloid mills.

In a third step, other additives such as surfactants, pH adjusters, rheology modifiers, biocides, and/or defoaming agents. Suitable rheology modifiers and other additives are described for example in McCutcheon's, Volume 2: Functional Materials published by MC Publishing Company annually. In one aspect, suitable commercially available rheology modifiers include silicone dioxides. In one aspect, suitable commercially available rheology modifiers include for example Acti-gel 208, Rhodapol 23, Aerosil, AEROSIL® R 202, AEROSIL® R 805, AEROSIL® R 812 S, AEROSIL® R 816, AEROSIL® R 972, AEROSIL® R 974, AEROSIL® 200, AEROSIL® 300, AEROSIL® 380, Bentonite, water, and combinations thereof. The rheology modifier, when present, may suitably be about 1 wt. %, about 2 wt. %, about 3 wt. %, or about 4 wt. %. In one aspect, the rheology modifier may be no more than 2 wt %. One of ordinary skill in the art will understand that when a rheology modifier is added, the density of the formulation may change and one or more amounts of the other formulation components, such as the active ingredient, the emulsifiers and/or wetting agents, and/or diluent may have to be changed accordingly. Suitable biocides include, but are not limited to bactericides such as Legend™ MK (mixture of 5-chloro-2-methyl-3(2H)-isothiazolone with 2-methyl-3(2H)-isothiazolone), EDTA (ethylenediamine-tetraacetic acid), formaldehyde, benzoic acid, or 1,2-benzisothiazol-3(2H)-one or its salts, e.g., Proxel® BD or Proxel® GXL (Arch), Actcide LA11029, Acticide SPX, Proxel GXL, KathonCG/ICP and KathonCG/ICPII. Suitable PH adjusters include, for example citric acid, tartaric acid, mandelic acid, acetic acid, succinic acid, hydrochloric acid, phosphoric acid, sulfuric acid, and sodium hydrogen sulfate.

In accordance with the present disclosure, it has been discovered that stable diamide insecticide oil dispersion concentrates of the present disclosure having desired rheological properties can be prepared without a rheological modifier, such as clay or silica. Surprisingly, it has been discovered that water can act as a rheology modifier. In one aspect, water may be present in the formulation at about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, and ranges constructed therefrom.

Diamide insecticide oil dispersion concentrates may be characterized as follows. A viscosity of about 200 cps to about 8,000 cps at 6 rpm measured by a Brookfield instrument with spindle L2. A particle size D50 of about 2 m measured by a laser diffraction technique. Dispersibility of the formulation in water is visually evaluated by adding an aliquot of about 0.5 ml concentrate to about 15 ml water such as standard Cipac D water (342 ppm hardness) in a glass vial. The mixtures are vortexed or shaken for about 15 sec until the sample is fully dispersed and then visually assessed. A stable dispersion should remain homogenously distributed within the water medium and not form visible agglomerates floating in the continuum phase. In some cases, agglomeration is manifested by visual formation of a thin film of agglomerated particles on the wall of the glass vial. If sedimentation occurs with time, the sediment is generally be re-dispersible upon agitation or inversion or vortexing. The time during which assessment takes place is usually within about the first 30 minutes after mixing the concentrate and water to about 24 hours after mixing the concentrate and water. The outcome of the dispersibility test in water is either “stable” or “not stable”. Spontaneity of bloom of the formulation in water is visually evaluated by adding an aliquot of about 0.5 ml concentrate to about 50 ml water such as Cipac D in a narrow glass tube with an average diameter of about 2 cm. The glass tube is not disturbed during the test. The goal is to evaluate the quality of emulsification of the concentrate in water without the help of any external aid such as inversion or shaking or agitation. The spontaneity of bloom is assessed as good, marginal or poor. “Good” is when the majority of the concentrate is self-emulsified, “marginal” is when the concentrate is partially emulsified and “poor” is when no emulsification is observed.

The process for preparing the SE compositions of the present disclosure comprises the following steps.

The first step generally involves preparation of a concentrated suspension concentrate (SC) of the active ingredient which may be done in process equipment known to those skilled in the art, such as an overhead agitator, a high shear mixer, high shear mill (e.g., a colloid mill) or a homogenizer. The diamide insecticide is dispersed in water, optionally in the presence of a dispersant. Additional pesticides may optionally be added to the water phase. In one aspect, the diamide and/or the additional pesticide can be added to a mixture of all non-biologically active agents of the composition. The dispersant may be a polymeric nonionic surfactant or anionic surfactant. For instance, in some aspects, the dispersant may be a non-ionic methyl methacrylate ethoxylated graft copolymer (e.g., Atlox® 4913) or an anionic modified styrene acrylic polymer (e.g. Metasperse™550s) or sodium alkylnaphthalenesulfonate, formaldehyde condensate (e.g. Morwet D 425) or salts of lignonsulfonates (e.g. Reax 88B or Borresperse NA). The dispersant concentration may suitably be about 1 wt. %, about 2 wt. %, about 3 wt. %, about 4 wt. %. about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, or about 15 wt % or in a range constructed from any of those values. In one aspect, one or more dispersants may be added. When present, the additional dispersant concentration may suitably be about 1 wt. %, about 2 wt. %, about 3 wt. %, about 4 wt. %. about 5 wt. %, about 6 wt. %, about 7 wt. %, about 8 wt. %, about 9 wt. % or about 10 wt. %, or about 11 wt. %, or about 12 wt. %, or about 13 wt. %, or about 14 wt. %, or about 15 wt. % or in a range constructed from any of those values. For instance, in some aspects, the additional dispersant may be a butyl block copolymer (e.g., Atlas® G 5002L) or an amphoteric polymeric dispersant (e.g., Atlox® 4915). Other additives such as surfactants, pH adjusters, rheology modifiers, anti-freeze agents, biocides, and/or defoaming agents may be added. In one aspect, the surfactants can be an alkoxylated alcohol (e.g. Agnique BP 420). One or more additives described in the third step below may optionally be added in the first step.

In an optional second step, the suspension from step 1 may be wet milled to reduce the average median particle size D50 to less than about 10 m and average particle size D90 to less than about 30 m. Particle size can be measured by a laser diffraction instrument known to those skilled in the art. Wet milling may be done in process equipment known in the art such as ball mills or colloid mills.

In a third step, oil phase comprised of TEHP and/or additional oil as described previously is added to the concentrated SC. The oil phase may optionally contain one or more surfactants. In one aspect, the surfactant can be anionic alkyl benzene sulfonate (e.g. Agnique ABS 60 C EH) or dioctyl sulfo succinate (e.g. Stepwet DOS 70) or phosphate ester surfactants (e.g. Dextrol OC 180) or sodium tridecyl ether sulfate (e.g. CEDEPAL TD-407). In another aspect, the surfactant can be nonionic vegetable oil ethoxylate such as castor oil ethoxylate (e.g. Agnique CSO 40) or soybean oil ethoxylate (e.g. Agnique SBO 30) or polyether sorbitol hexaoleate (e.g. Cirrasol G 1086) or polyoxypropylene-polyoxyethylene block copolymer (e.g. Pluronic F98). Optionally, the oil phase can be added as an EW formulation. EW formulation could be obtained by homogenizing oil phase in the presence of surfactants and water. In one aspect, under agitation, the diamide SC formulation can be mixed with TEHP EW formulation, resulting in the final SE formulation.

Cyantraniliprole SE formulations may be prepared as follows. In an agitated tank, such as beaker or other types of vessel, formulation inert ingredients, namely carrier oil and surfactants, were weighted and mixed with cyantraniliprole active ingredient. The well mixed slurry was then fed to beads milling device such as Eiger mill, attritor mill, etc. Under cooling, cyantraniliprole was milled to desired particle size, typically, d50 less than 10 um, preferably, less than 2.5 um. The formulation was finalized, optionally, by addition of thickener(s).

Non-limiting examples of oil dispersion concentrates of the present disclosure are indicated in Table A below.

TABLE A

| Composition | A1 | | A2 | | A3 | | A4 | | A5 | |
|---|---|---|---|---|---|---|---|---|---|---|
| Diamide Insecticide | 4-40 | wt. % | 15-40 | wt. % | 20-35 | wt. % | 25-35 | wt. % | 30 wt. % | |
| Phosphate Ester | 2-80 | wt. % | 10-70 | wt. % | 35-55 | wt. % | 40-50 | wt. % | 45 wt. % | |
| Surfactant/Emulsifier | 5-65 | wt. % | 5-40 | wt. % | 15-35 | wt. % | 20-30 | wt. % | 25 wt. % | |
| Water | 0-5 | wt. % | 0-4 | wt. % | 0-3 | wt. % | 0-2 | wt. % | 0 | |
| Oil | 0-50 | wt. % | 0-40 | wt. % | 0-30 | wt. % | 0-20 | wt. % | 0 | |
| Composition | A6 | | A7 | | A8 | | A9 | | A10 | |
| Chlorantraniliprole | 4-40 | wt. % | 15-40 | wt. % | 20-35 | wt. % | 25-35 | wt. % | 30 wt. % | |
| Phosphate Ester | 2-80 | wt. % | 10-70 | wt. % | 35-55 | wt. % | 40-50 | wt. % | 45 wt. % | |
| Surfactant/Emulsifier | 5-65 | wt. % | 5-40 | wt. % | 15-35 | wt. % | 20-30 | wt. % | 25 wt. % | |
| Water | 0-5 | wt. % | 0-4 | wt. % | 0-3 | wt. % | 0-2 | wt. % | 0 | |
| Composition | A11 | | A12 | | A13 | | A14 | | A15 | |
| Cyantraniliprole | 4-45 | wt. % | 15-40 | wt. % | 15-40 | wt. % | 15-35 | wt. % | 15-35 | wt. % |
| Phosphate Ester | 2-80 | wt. % | 25-60 | wt. % | 20-40 | wt. % | 5-20 | wt. % | 5-20 | wt. % |
| Surfactant/Emulsifier | 10-65 | wt. % | 20-40 | wt. % | 10-30 | wt. % | 40-65 | wt. % | 10-30 | wt. % |
| Water | 0-5 | wt. % | 0-4 | wt. % | 0-5 | wt. % | 0-5 | wt. % | 0-5 | wt. % |
| Oil | 0-50 | wt. % | 0-50 | wt. % | 10-30 | wt. % | 5-20 | wt. % | 25-50 | wt. % |

Tank Mix

In some aspects, a tank mix is defined as a mixture of one or more biologically active compositions and/or adjuvants. The tank mix may further be diluted with water or other carriers suitable for spraying. These additional adjuvants are commonly known as “spray adjuvants” or “tank-mix adjuvants”, and include any substance added to a tank mix to improve the performance of a pesticide or alter the physical properties of the tank mix. Adjuvants can be surfactants, emulsifying agents, petroleum-based crop oils, crop-derived seed oils, pH adjusters, thickeners, spreader stickers and/or defoaming agents, as described elsewhere herein. Adjuvants may be used to enhance efficacy (e.g., biological availability, adhesion, penetration, uniformity of coverage and durability of protection), or minimize or eliminate spray application problems associated with incompatibility, foaming, drift, evaporation, volatilization and degradation. To obtain optimal performance, adjuvants are selected with regard to the properties of the active ingredient, formulation and target (e.g., crops, insect pests). Representative exemplary surfactants include Silwet® (Helena Chemical Company) polyalkyleneoxide modified heptamethyltrisiloxane and Assist® (BASF) 17% surfactant blend in 83% paraffin based mineral oil.

Among the tank mix adjuvants, oils including crop oils, crop oil concentrates, vegetable oil concentrates and methylated seed oil concentrates are most commonly used to improve the efficacy of pesticides, possibly by means of promoting more even and uniform spray deposits. In situations where phytotoxicity potentially caused by oils or other water-immiscible liquids are of concern, tank mix compositions prepared from the composition of the present disclosure will generally not contain oil-based adjuvants. However, in situations where phytotoxicity caused by oil-based adjuvants is commercially insignificant, tank mix compositions prepared from the composition of the present composition can also contain oil-based adjuvants, which can potentially further increase control of invertebrate pests, as well as rainfastness.

Products identified as “crop oil” typically contain 95 to 98% paraffin or naphtha-based petroleum oil and 1 to 2% of one or more surfactants functioning as emulsifiers. Products identified as “crop oil concentrates” typically consist of 80 to 85% of emulsifiable petroleum-based oil and 15 to 20% of nonionic surfactants. Products correctly identified as “vegetable oil concentrates” typically consist of 80 to 85% of vegetable oil (i.e., seed or fruit oil, most commonly from cotton, linseed, soybean or sunflower) and 15 to 20% of nonionic surfactants. In some aspects, adjuvant performance can be improved by replacing the vegetable oil with methyl esters of fatty acids that are typically derived from vegetable oils. Examples of methylated seed oil concentrates include MSO® Concentrate (UAP-Loveland Products, Inc.), Premium MSO Methylated Spray Oil (Helena Chemical Company), and Adigor® (Syngenta) 47% methylated rapeseed oil in liquid hydrocarbons.

The amount of adjuvants added to tank mixes generally does not exceed about 2.5% by volume, and more typically the amount is from about 0.1 to about 1% by volume. The application rates of adjuvants added to tank mixes are typically between about 1 to 5 L per hectare.

For aerial applications, in some embodiments, the amount of adjuvants added to tank mixes generally does not exceed about 2.5% by volume, typically the amount is from about 0.25 to about 1% by volume, and more typically the amount is from about 0.125 to about 0.5% by volume. The application rates of adjuvants added to tank mixes are typically between about 1 to 5 L per hectare.

Application

To achieve contact and control of phytophagous pests, tank mixes of the present disclosure may be applied to plant foliage (e.g., leaves, stems, flowers and/or fruits). In certain applications, the formulations may be applied to plant roots (such as by a soil drench or by a nursery box treatment or a dip of transplants) and/or to seeds. Compounds of the disclosure may also be effective by localized application to a locus of infestation.

The rate of application required for effective control (i.e. “biologically effective amount”) will depend on such factors as the species of invertebrate to be controlled, the pest's life cycle, life stage, its size, location, time of year, host crop or animal, feeding behavior, mating behavior, ambient moisture, temperature, and the like. Under normal circumstances, application rates of about 0.01, 0.025, 0.05, 0.1, 0.2, 0.3, 0.4 or 0.5 kg of diamide insecticide per hectare are sufficient to control phytophagous pests.

In some aspects, tank mix formulations may be suitable for foliar use by aerial or ground application. Spray volumes can range from about one to several thousand liters per hectare, but more typically are in the range from about ten to several hundred liters per hectare. In some aspects, tank mix formulations can be metered directly into drip irrigation systems or metered into the furrow during planting. In some aspects, tank mix formulations can be applied onto seeds of crops and other desirable vegetation as seed treatments before planting in order to protect developing roots and other subterranean plant parts and/or foliage through systemic uptake.

In one aspect, the liquid formulation compositions disclosed herein are suitable for use in a drip irrigation systems, furrow during planting, handheld sprayers, backpack sprayers, boom sprayers, ground sprayers, aerial application, and unmanned aerial vehicles.

In some aspects, tank mix adjuvants may affect the droplet density and/or spray coverage of a composition disclosed herein, when applied to plants via an aerial delivery system. In these aspects, suitable tank mix adjuvants include but are not limited to organosilicones, such as Y-20079 (manufactured by Momentive Trading Co. Ltd., Shanghai, China). Other examples include but are not limited to the vegetable oil Maifei, manufactured by Grand AgroChem Co., Ltd., Beijing, China. Other examples include but are not limited to the vegetable oil Beidatong, manufactured by Hebei Mingshun Agricultural Technology Co. Ltd., Shijiazhuang, China. Other examples include but are not limited to the high molecular weight polymer Nongjianfei, manufactured by Guilin Jiqi Group Co. Ltd., Guilin, China. Other examples include but are not limited to the high molecular weight polymer Star Guar X, manufactured by Solvay Chemical Shanhai Co., Ltd., Shanghai, China.

Other examples of tank mix adjuvants suitable for use in an aerial delivery system include deposition enhancing agents, water conditioners, pH modifiers, crop oils, petroleum or paraffinic oils, vegetable oils, methylated seed oils, agents that reduce evaporation, and combinations thereof.

Examples of methods suitable to deliver the liquid formulation compositions disclosed via unmanned aerial vehicles may be found in Wang et al, Int. J. Precis. Agric. Aviat., Vol 3, No. 2 pg 65-72 (2020).

Another example of a method suitable to deliver the liquid formulation compositions disclosed via unmanned aerial vehicles may be found in Li et al., Pest Management Science, 19 Aug. 2020.

In some aspects of the disclosure, the plants are infested with the phytophagous pests prior to application of the amide insecticide. In some other aspects, the plants are not infested with the phytophagous pests prior to application of the amide insecticide.

### EXAMPLES

Efficacy Evaluation Methods

Method 1 (Soybean Translaminar). Soybean plants were grown in a growth chamber. When the first trifoliate expanded, the terminal bud was removed. A 2.4 cm diameter circumference was drawn on the terminal leaflet of the first trifoliate and five 0.002 ml droplets were deposited within the circle. Application to the leaflet can also be done by spraying the solution. Formulations were applied with the active ingredient diluted to 100 ppm. Three days after the droplets were applied, four 1, instar cabbage looper Trichoplusia ni larvae were placed on the underside of the circle in a clip cage. This setup is replicated on five plants. Results are evaluated 24 hours later and larval mortality is determined.

Method 2 (Phytotoxicity). Plants of the crop of interest were grown in a greenhouse until the appropriate size was reached. Plants were sprayed using a belt sprayer at 50 gal/ac or other rates if necessary. After 7 and 14 days, phytotoxicity (%) was evaluated based on whole-plant assessment taking into account area damaged and intensity.

Method 3 (Soybean Translocation stem swab). Soybean plants are grown in a growth chamber until the second trifoliate is expanded. Treatments are applied to the stem between trifoliates with the help of a cotton swab. Formulations were applied with the active ingredient diluted to 1000 ppm. Three days after application, the second trifoliate (expanded at application) and the third trifoliate (small bud at application) were collected for bioassaying. Leaf pieces were exposed to neonate fall armyworm Spodoptera frugiperda larvae and larval mortality was determined 4 days after setup.

Method 4 (Cotton Translaminar). Cotton plants were grown in a growth chamber until the first true leaf had expanded. Test plants were placed in a cage containing other plants harboring a large number of adult silverleaf whiteflies Bemisia tabaci. Whiteflies lay eggs on the underside of the leaves of the test plants, and plants were removed from the case when the desired number of eggs had been laid. Eggs hatched and the crawlers attached to the underside of the leaf. Ten days after infestation, the upper surface of the leaf was sprayed at 50 gal/ac with an overhead nozzle. Mortality was determined 4-6 days later.

Method 5 (Leaf penetration and Rainfastness). Soybean plants were grown in a growth chamber until the first trifoliate had expanded. The terminal bud was then removed. A 2.4 cm diameter circumference was drawn on the terminal leaflet of first trifoliate and five 0.002 ml droplets were deposited within the circle. Formulations were applied with the active ingredient diluted to 100 ppm. Two hours later the plants were exposed to 75 mm of simulated rain in one hour. Three days after simulated rain, four 1st instar cabbage looper Trichoplusia ni larvae were placed on the underside of the circle in a clip cage. This setup was replicated on five plants. Results were evaluated 24 hours later and larval mortality was determined.

Method 6 (Soybean Bud Retention). Soybean plants were grown in a growth chamber until the second trifoliate had expanded and the third trifoliate formed a small bud. Formulations were sprayed at 100 l/ha with the active ingredient diluted to 100 ppm. Plants were held for 7 days and the expanded third trifoliate were collected for bioassaying. Leaf pieces were exposed to neonate fall armyworm Spodoptera frugiperda larvae and larval mortality was determined 3 days after setup.

Method 7 (Translocation in leaves). Soybean plants were grown in a growth chamber until the first trifoliate had expanded. Formulations were applied to the terminal end of a leaf, within a 2.4 cm circle (five 2 μl droplets, at a concentration of 250 ppm). Following treatment, the plants were held in a growth chamber. Three days after treatment, the treated leaves were excised from the plant. The treated area of each leaf was cut and removed from the untreated area of the leaf. The treated and untreated leaf pieces were then placed into separate respective tray cells of a 16 cell tray with moist filer paper. Four 2-day old Trichoplusia ni. were placed on each of a treated portion of an excised leaf, and an untreated portion of an excised leaf. Percent insect mortality and percent feeding level were evaluated 4 days after insect infestation. Results are show in Example 11.

Method 8 (Translocation from petioles or stems). Soybean plants were grown in a growth chamber until the first trifoliate had expanded. Formulations were applied to the petiole of the 1 trifoliate (five 2 μl droplets, at a concentration of 250 ppm). Treated plants were laid on their side until the formulations had dried. Following treatment, the plants were held in a growth chamber. Three days after treatment, the plants were removed, and the newest-growth leaflet of the 1 trifoliate was removed and cut in half. Each half was placed into a separate well of a 16 cell tray with moist filer paper. Four 2-day old Trichoplusia ni. were placed in each cell. Percent insect mortality and percent feeding level were evaluated 4 days after insect infestation. Results are show in Example 12 (n=5, per treatment).

In parallel, soybean plants were grown in a growth chamber until the first trifoliate had expanded. Formulations were applied to the petiole of the 1^{st} and 2^{nd} trifoliates (five 2 μl droplets, at a concentration of 250 ppm). Treated plants were laid on their side until the formulations had dried. Following treatment, the plants were held in a growth chamber. Three days after treatment, the plants were removed, and the newest-growth leaflet of the 2^{nd} trifoliate was removed and cut in half. Each half was placed into a separate well of a 16 cell tray with moist filer paper. Four 2-day old Trichoplusia ni. were placed in each cell. Percent insect mortality and percent feeding level were evaluated 4 days after insect infestation. Results are show in Example 13 (n=5, per treatment).

Method 9 (Application of an OD Formulation to Rice via Unmanned Drone). An OD formulation described herein was applied to an Indica inbred rice variety transplanted, in West Java, Indonesia during a rice yellow stem borer Scirpophaga incertulas infestation. Application timing occurred at peak egg hatch and performed using an unmanned drone aircraft from DJI manufacturer, model Agras MG 1-P. The drone applied OD formulations and control treatment of Prevathon® insect control, at the rates indicated. The unmanned drone was flown at a speed of 25.1 km/hour, at a height of 1.5 m, and applied the products within a 4 m swath at a flowrate of 1.04 minute. Only one application was made using a spray volume of approximately 30.3 L/ha that included a tank mix of water and the respectively identified products. Nothing else was added to the tank. The experiment used a single 150 m² large plot design. Evaluations of treatment efficacy were made at 3, 7,10,14, 21, and 28 days after application. At each evaluation date the % of “dead heart*” damage (larval feeding damage causing death of the central leaf whorl at the vegetative stage) was assessed in all treatments including the untreated check (UTC). The results are reported in Example 13.

Formulation ingredients used in the compositions provided in the examples are indicated in Table B below.

TABLE B

| Formulation | | |
|---|---|---|
| Ingredients | Category | Description |
| Agnique ME 18 SD | Oil | Methylated seed oil (also known as |
| U- AO | | methylated soybean oil or methyl ester |
| | | of soybean oil or MSO or methyl |
| | | soyate) (CAS# 68919-53-9 or 67784- |
| | | 80-9) |
| Agnique 60 C ABS | Anionic | Alkyl benzene sulfonate (also known |
| EH | Surfactant | as calcium alkyl benzene sulfonate or |
| | | calcium dodecyl benzene sulfonate) |
| | | (CAS# 26264-06-2) |
| Atlas G-5002L | Nonionic | Butyl block copolymer (also known as |
| | Surfactant | ethoxylated propoxylated block co- |
| | | polymer, butyl terminated)) |
| Atlox 4914 | Nonionic | Random copolymer of polyolefin and |
| | Surfactant | polyethylene oxide (proprietary) |
| Atlox LP-1 | Anionic | Poly(12-hydroxystearic acid) (CAS# |
| | Surfactant | 58128-22-6) |
| Break Thru S240 | Nonionic | Polyether-modified polysiloxane |
| | Surfactant | (CAS# 134180-76-0) |
| Break Thru SP 133 | Nonionic | Polyglycerol esters and fatty acid |
| | Surfactant | esters |
| Cirrasol G 1086 | Nonionic | Polyoxyethylene sorbitol fatty acid |
| | Surfactant | ester (also known as Polyoxyethylene |
| | | (40) sorbitol hexaoleate or |
| | | Polyoxyethylene sorbitol hexaoleate) |
| | | (CAS# 57171-56-9) |
| Cirrasol G 1096 | Nonionic | Polyoxyethylene sorbitol fatty acid |
| | Surfactant | ester (also known as Polyoxyethylene |
| | | (50) sorbitol hexaoleate or |
| | | Polyoxyethylene sorbitol hexaoleate) |
| | | (CAS# 57171-56-9) |
| Codacide | Oil | Canola oil (95%) and polyethoxylated |
| | | ester (5%) |
| DISFLAMOLL | Oil | Tris-2-ethylhexyl phosphate (TEHP) |
| TOF | | (CAS# 78-42-2) |
| Ecosurf EH-6 | Nonionic | 2-Ethyl Hexanol EO-PO Nonionic |
| | Surfactant | Surfactant (CAS# 64366-70-7) |
| Ecosurf EH-9 | Nonionic | 2-Ethyl Hexanol EO-PO Nonionic |
| | Surfactant | Surfactant (CAS# 64366-70-7) |
| Rhodacal 60 BE | Anionic | Mixture of linear |
| | Surfactant | dodecylbenzenesulphonic acid, |
| | | calcium salt, and isobutyl alcohol |
| | | (CAS# 26264-06-2) |
| Silwet HS 312 | Nonionic | Polyalkyleneoxide Silane + alcohol |
| | Surfactant | ethoxylate (Proprietary) |
| Tergitol 15-S-7 | Nonionic | Alcohols, C₁₂₋₁₄-secondary, |
| | Surfactant | ethoxylated (CAS# 84133-50-6) |
| Lutensol XL 50 | Nonionic | Oxirane, 2-methyl-, polymer with |
| | Surfactant | oxirane, mono(2-propylheptyl) ether |
| | | (CAS# 166736-08-9) |
| Lutensol XL 60 | Nonionic | Oxirane, 2-methyl-, polymer with |
| | Surfactant | oxirane, mono(2-propylheptyl) ether |
| | | (CAS# 166736-08-9) |
| Lutensol XP 50 | Nonionic | Poly(oxy-1,2-ethanediyl), .alpha.-(2- |
| | Surfactant | propylheptyl)-.omega.-hydroxy- |
| | | (CAS# 160875-66-1) |
| Lutensol XP 60 | Nonionic | Poly(oxy-1,2-ethanediyl), .alpha.-(2- |
| | Surfactant | propylheptyl)-.omega.-hydroxy- |
| | | (CAS# 160875-66-1) |
| Atlox 4915 | Nonionic | Polymeric dispersant, CAS# |
| | Surfactant | proprietary |
| Soprophor 796P | Nonionic | Ethoxylated propoxylated |
| | Surfactant | polyarylphenol (CAS# 70880-56-7) |
| Aerosil 200 | Rheology | amorphous silicon dioxide (also |
| | Modifier | known as amorphous silica) (CAS# |
| | | 112945-52-5, 7631-86-9) |
| Aerosil R974 | Rheology | Hydrophobic colloidal silica (silicon |
| | Modifier | dioxide) (CAS# 68611-44-9) |
| Agnique AMD 10 | Solvent | N, N-dimethyldecanamide (CAS# |
| | | 14433-76-2) |
| Emulsogen MTP | Nonionic | Alcohols, C16-18, ethoxylated |
| 070 | Surfactant | propoxylated (CAS# 68002-96-0) |
| Agnique CSO 30 | Nonionic | Castor oil, ethoxylated (also known as |
| | Surfactant | PEG-30 Castor Oil; Polyoxyethylene |
| | | (30) Castor Oil, PEO 30 Castor Oil) |
| | | (CAS# 61791-12-6) |
| Agnique CSO 35 | Nonionic | Castor oil, ethoxylated (also known as |
| | Surfactant | PEG-35 Castor Oil; Polyoxyethylene |
| | | (35) Castor Oil, PEO 35 Castor Oil) |
| | | (CAS# 61791-12-6) |
| Agnique CSO 40 | Nonionic | Castor oil, ethoxylated (also known as |
| | Surfactant | PEG-40 Castor Oil; Polyoxyethylene |
| | | (40) Castor Oil, PEO 40 Castor Oil) |
| | | (CAS# 61791-12-6) |
| Canola oil | Oil | Crop oil, CAZS#120962-03-0 |
| Isopar M | Oil | IsoParaffin oil, CAS# 64742-47-8 |
| Sunspray 6N, 11N | Oil | IsoParaffin oil, CAS#64742-56-9 |
| Stepan C65 | Oil | Fatty acid methyl ester CAS#67762- |
| | | 38-3 |
| Aromatic 150ND | Oil | Aromatic solvent CAS#64742-94-5 |
| Aromatic 200ND | Oil | Aromatic solvent CAS#64742-94-5 |
| Stepwet DOS 70 | Anionic | Dioctyl sodium sulfosuccinate |
| | Surfactant | CAS# 577-11-7 |
| Stepwet DOS 70PG | Anionic | CAS# 577-11-7 |
| | Surfactant | |
| Stepwet DOS | Anionic | CAS# 577-11-7 |
| 60ROE | Surfactant | |
| Stepwet DOS 600E | Anionic | CAS# 577-11-7 |
| | Surfactant | |
| Stepwet DOS 64A | Anionic | CAS# 577-11-7 |
| | Surfactant | |
| Atlox 4913 | Nonionic | Methyl methacrylate ethoxylated graft |
| | Surfactant | copolymer (CAS# 119724-54-8) |
| Atlox 4894 | Nonionic | Proprietary |
| | Surfactant | |
| Agnique BP 420 | Nonionic | Fatty alcohol alkoxylate (EO-PO) |
| | Surfactant | |
| Metasperse 550 S | Anionic | Modified styrene acrylic polymer |
| | Surfactant | (CAS# proprietary) |
| Synergen W06 | Nonionic | Fatty alcohol alkoxylate (EO-PO) |
| | Surfactant | |
| Brij CS17 | Nonionic | Ethoxylated alcohol based on |
| | Surfactant | cetostearyl alcohol |

### Example 1

### Example 1A

The efficacy on Trichoplusia ni of the tank mix combination of chlorantraniliprole and TEHP was evaluated versus chlorantraniliprole in the absence of TEHP, and an untreated control (“UTC”) according to Method 1. Chlorantraniliprole was delivered by a commercially available suspension concentrate (SC) that does not contain TEHP. The results are provided in Table 1A below where “CTPR” refers to Chlorantraniliprole and “Tank Mix Comp” refers to tank mix composition.

TABLE 1A

| Tank | | | | |
|---|---|---|---|---|
| Mix | | | | |
| Comp | CTPR | TEHP | TEHP:CTPR | % Mortality |
| 1 | 100 ppm | 1200 ppm | 12:1 | 100 |
| 2 | 100 ppm | 600 ppm | 6:1 | 100 |
| 3 | 100 ppm | 300 ppm | 3:1 | 100 |
| 4 | — | 1200 ppm | — | 0 |
| 5 | 100 ppm | — | — | 10 |
| UTC | — | — | — | 0 |

The results indicate that all ratios of TEHP:Chlorantraniliprole improved the translaminar activity of chlorantraniliprole leading to an improved insect mortality over the untreated control, over the tank mix that contained only TEHP and over the tank mix that contained only chlorantraniliprole without TEHP.

### Example 1B

The efficacy on Trichoplusia ni of the tank mix combination of chlorantraniliprole and TEHP was repeated as in Example 1A with additional lower concentrations of TEHP while maintaining Chlorantraniliprole constant at 100 ppm, with evaluation done according to Method 1. Chlorantraniliprole was delivered by a commercially available SC formulation that does not contain TEHP. The results are provided in Table 1B below.

TABLE 1B

| Tank | | | | |
|---|---|---|---|---|
| Mix | | | | |
| Comp | Chlorantraniliprole | TEHP | TEHP:Chlorantraniliprole | % Mortality |
| 1 | 100 ppm | 600 ppm | 6:1 | 100 |
| 2 | 100 ppm | 300 ppm | 3:1 | 90 |
| 3 | 100 ppm | 150 ppm | 1.5:1 | 80 |
| 4 | 100 ppm | 75 ppm | 0.75:1 | 75 |
| 5 | 100 ppm | 37.5 ppm | 0.375:1 | 45 |
| 4 | — | 600 ppm | — | 5 |
| 5 | 100 ppm | — | — | 35 |
| UTC | — | — | — | 10 |

The results indicate that all ratios of TEHP:Chlorantraniliprole in Table 1B improved the translaminar activity of chlorantraniliprole leading to an improved insect mortality over the untreated control, over the tank mix that contained only TEHP and over the tank mix that contained only chlorantraniliprole without TEHP. These results show the leaf penetration power of TEHP at low concentrations in the tank mix enables higher active ingredient loading, up to about 50% of the formulation. To the contrary, a high active ingredient strength formulation with MSO will not contain enough MSO to maintain biological efficacy.

### Example 1C

The efficacy on Trichoplusia ni of the tank-mix combination of chlorantraniliprole and various excipients was evaluated versus chlorantraniliprole in the absence of TEHP and versus an untreated control according to Method 1. Chlorantraniliprole was delivered by a commercially available SC formulation that does not contain TEHP. The results are provided in Table 1C below where “CTPR” refers to chlorantraniliprole, “Tank Mix Comp” refers to tank mix composition and “MSO” refers to Agnique ME 18 SD U-AO (methylated soybean oil).

TABLE 1C

| Tank | | | | |
|---|---|---|---|---|
| Mix | | | | |
| Comp | CTPR | MSO | TEHP | % Mortality |
| 1 | 100 ppm | 600 ppm | — | 45 |
| 2 | 100 ppm | 300 ppm | — | 65 |
| 3 | 100 ppm | 300 ppm | 300 ppm | 85 |
| 4 | 100 ppm | 150 ppm | 150 ppm | 85 |
| 7 | 100 ppm | — | 600 ppm | 95 |
| 8 | 100 ppm | — | 300 ppm | 100 |
| 9 | 100 ppm | — | — | 15 |
| UTC | — | — | — | 10 |

The results indicate that the combination of chlorantraniliprole, TEHP and a 50/50 blend of MSO:TEHP improved leaf penetration of chlorantraniliprole as compared to MSO alone. 300 ppm TEHP resulted in higher mortality as compared to each of 300 and 600 ppm MSO.

### Example 1D

Oil dispersion (OD) compositions comprising Chlorantraniliprole were prepared as summarized in Tables 1D to 1F below, wherein all amounts are reported as percent of the total formulation (% w/w). Compositions denoted with “C” prefix are comparative compositions falling outside the scope of the disclosure and are used to demonstrate the benefits of the compositions of the disclosure. Composition 1 contained built in TEHP. Composition 2 contained both built in TEHP and methylated soybean oil (MSO). Compositions 3 and 4 are comparative examples containing built in MSO. Composition 5 is a comparative example of a commercial SC formulation, which contains neither TEHP nor MSO. The results were evaluated according to Method 1

TABLE 1D

| | Composition | | | | |
|---|---|---|---|---|---|
| Ingredient | 1 | 2 | C3 | C4 | C5 |
| Chlorantraniliprole | 10 | 10 | 10 | 5 | 5 |
| Atlox LP-1 | 4 | 4 | 4 | 4 | — |
| Atlox 4915 | 0.5 | 0.5 | 0.5 | 0.5 | — |
| Atlas G-5002L | 0.5 | 0.5 | 0.5 | 0.5 | — |
| Agnique 60 C ABS EH | 6.3 | 3.15 | 6.3 | 3.34 | — |
| Aerosil 200 | 1 | 1 | 1 | — | — |
| Cirrasol G-1086 | 6.3 | 6.93 | — | 7.34 | — |
| Emulsogen MTP 070 | — | 2.52 | 6.3 | — | — |
| Agnique AMD 10 | — | — | — | 15.13 | — |
| Soprophor 796P | — | — | — | 2.67 | — |
| DISFLAMOLL TOF (TEHP) | 71.4 | 35.7 | — | — | — |
| Agnique ME 18 | — | 35.7 | 71.4 | 60.52 | — |
| SD U-AO (MSO) | | | | | |
| SC Formulation | — | — | — | — | 95 |
| Components | | | | | |
| Total | 100 | 100 | 100 | 100 | 100 |
| TEHP:Chlorantraniliprole | 7:1 | 3.6:1 | — | — | — |
| MSO:Chlorantraniliprole | — | 3.6:1 | 7:1 | 12:1 | — |
| % Mortality | 90 | 75 | 50 | 85 | 5 |
| (Method 1) | | | | | |

TABLE 1E

| | Composition | | | | |
|---|---|---|---|---|---|
| Ingredient | 6 | 7 | 8 | 9 | 10 |
| Chlorantraniliprole | 10 | 30 | 30 | 30 | 30 |
| Atlox LP-1 | 4 | 1 | 0.5 | 0.5 | 1 |
| Atlox 4915 | 0.5 | 3 | 1.5 | 1.5 | — |
| Atlas G-5002L | 0.5 | — | — | — | — |
| Agnique 60 C ABS EH | 8.4 | 9.24 | 10 | 10 | 10 |
| Aerosil 200 | 1 | — | — | — | — |
| Cirrasol G-1086 | 8.4 | — | — | — | — |
| Agnique CSO 30 | — | 14.52 | 15 | 10 | — |
| Ecosurf EH-6 | — | — | — | — | 15 |
| DISFLAMOLL TOF (TEHP) | 67.2 | 42.24 | 43 | 48 | 44 |
| Total | 100 | 100 | 100 | 100 | 100 |
| TEHP:Chlorantraniliprole | 6.7:1 | 1.4:1 | 1.4:1 | 1.6:1 | 1.5:1 |
| % Mortality | Not | 95 | Not | Not | Not |
| (Method 1) | tested | | tested | tested | tested |

TABLE 1F

| | Composition | | | | |
|---|---|---|---|---|---|
| Ingredient | 11 | 12 | 13 | 14 | 15 |
| Chlorantraniliprole | 30 | 30 | 30 | 30 | 30 |
| Atlox LP-1 | 3 | 0.5 | 0.5 | 3 | 1 |
| Atlox 4915 | — | 1.5 | 1.5 | — | 3 |
| Agnique 60 C ABS EH | 10 | 15 | 8 | 8 | 9.57 |
| Aerosil 200 | — | — | — | — | |
| Cirrasol G-1086 | — | — | — | — | 4.95 |
| Agnique CSO 30 | 15 | 10 | 15 | 15 | — |
| DISFLAMOLL TOF (TEHP) | 42 | 43 | 45 | 44 | 51.48 |
| Total | 100 | 100 | 100 | 100 | 100 |
| TEHP:Chlorantraniliprole | 1.4:1 | 1.4:1 | 1.5:1 | 1.5:1 | 1.7:1 |
| % Mortality | Not | Not | Not | 90 | Not |
| (Method 1) | tested | tested | tested | | tested |

Composition 1 (Table 1D), containing built in TEHP, showed enhanced biological efficacy compared to comparative composition C3 containing built in MSO at the same ratio of oil to Chlorantraniliprole (7:1). At twice lower ratio of TEHP to Chlorantraniliprole (3.6:1), Composition 2 showed enhanced biological activity compared to composition C3. Composition 1 showed similar efficacy to Composition C4 despite the lower ratio of oil to Chlorantraniliprole. The results in Table 1D indicate that TEHP enhances the biological efficacy of Chlorantraniliprole in comparison to comparative compositions with MSO. Compositions in Tables 1E and 1F which were not tested by method 1 are expected to show similar performance as composition 1 in Table 1D.

### Example 2

Soybean and rice response to the chlorantraniliprole compositions of Example 1 compositions 1, 2 and C₃-C₅ were evaluated according to method 2. No phytotoxicity was observed after 7 DAT or 14 DAT in both soybean and rice cases.

### Example 3

The efficacy on Spodoptera frugiperda of composition 1 (Table 1D), containing built in TEHP, was evaluated according to Method 3 versus chlorantraniliprole as a commercially available SC formulation that does not contain built in TEHP. Both formulations were applied at a rate of 1000 ppm of chlorantraniliprole. The results are provided in Table 3 below where “CTPR” refers to Chlorantraniliprole.

TABLE 3

| | | % Mort | % Mort |
|---|---|---|---|
| Composition | CTPR | (trifoliate 2) | (trifoliate 3) |
| Commercial SC | 1000 ppm | 4.2 | 0 |
| formulation | | | |
| Composition 1 | 1000 ppm | 100 | 100 |
| Example 1D, | | | |
| Table 1D) | | | |

The results indicate that chlorantraniliprole composition 1, containing built in TEHP and applied at a rate of 1000 ppm chlorantraniliprole, shows 100% mortality in the soybean translocation stem swab test compared to a SC composition that does not contain TEHP.

### Example 4

### Example 4A

The efficacy on whitefly of composition 1 (Table 1D), which according to the present invention contains built in TEHP, was evaluated according to Method 4 versus chlorantraniliprole as a commercially available SC formulation which does not contain built in TEHP. Both formulations were applied at a rate of 300 ppm of chlorantraniliprole. The results are provided in Table 4A below where “CTPR” refers to Chlorantraniliprole and “Comp” refers to Composition.

TABLE 4A

| Comp | CTPR | % Mortality |
|---|---|---|
| C5 | 300 ppm | 1 |
| Composition 1 (Example 1D, | 300 ppm | 92 |
| Table 1D) | | |

### Example 4B

The efficacy on whitefly of compositions 1 (Table 1D) and 7 (Table 1E) of the present disclosure, containing built in TEHP, were evaluated according to Method 4 versus chlorantraniliprole as a commercially available SC formulation which does not contain built in TEHP. Chlorantraniliprole was applied at a rate of 300 ppm. The results are provided in Table 4B below where the “ratio” refers to the weight ratio of TEHP to active and “Comp” refers to Composition.

TABLE 4B

| | Active | Active, | | | % |
|---|---|---|---|---|---|
| Comp | Type | ppm | TEHP | Ratio | Mort |
| 1 | Chlorantraniliprole | 300 ppm | 2142 ppm | 7.1:1 | 100 |
| 7 | Chlorantraniliprole | 300 ppm | 420 ppm | 1.4:1 | 75 |
| Commercial | Chlorantraniliprole | 300 ppm | — | — | 0 |
| SC | | | | | |
| formulation | | | | | |

The results indicate that, at 300 ppm Chlorantraniliprole, both compositions 1 and 7 containing built in TEHP, show higher mortality in the cotton whitefly translaminar test compared to a comparative SC composition that does not contain TEHP. This is a surprising result for a foliar chlorantraniliprole formulation without added adjuvant when used in a tank mix.

### Example 4C (Method 1)

The efficacy on Trichoplusia ni of the formulation compositions 1 (Table 1D) and 7 (Table 1E) and tank mix compositions 3, 4, 5 and 6 in Table 4C below were evaluated by Method 1. Tank mix compositions 3-6 below were commercially available chlorantraniliprole SC formulations not containing TEHP. In Table 4C below, “Tank Mix Comp” refers to tank mix composition, “MSO” refers to Agnique ME 18 SD U-AO (methylated soybean oil). Tank mix composition 3 contained 100 ppm chlorantraniliprole and 150 ppm TEHP. Tank mix composition 4 contained 100 ppm chlorantraniliprole and 100 ppm TEHP. Tank mix composition 5 contained 100 ppm chlorantraniliprole and 150 ppm MSO. Tank mix composition contained 100 ppm chlorantraniliprole with no added TEHP or MSO.

TABLE 4C

| Comp | Active | TEHP | MSO | % Mort |
|---|---|---|---|---|
| 1 (Table 1D) | 100 ppm | 714 ppm | — | 95 |
| 7 (Table 1E) | 100 ppm | 140 ppm | — | 95 |
| 3 (Tank Mix Comp) | 100 ppm | 150 ppm | — | 85 |
| 4 (Tank Mix Comp) | 100 ppm | 100 ppm | — | 45 |
| 5 (Tank Mix Comp) | 100 ppm | — | 150 ppm | 10 |
| 6 (Tank Mix Comp) | 100 ppm | — | — | 5 |

The results indicate that both OD compositions 1 and 7 containing built in TEHP show higher insect mortality than tank mix composition 6 containing chlorantraniliprole delivered from SC formulation that does not contain TEHP. Composition 7 contains 30 wt. % Chlorantraniliprole and thus a lower amount of built in TEHP compared to composition 1, which contains 10 wt. % of chlorantraniliprole. Despite the lower amount of built in TEHP, composition 7 shows similar insect mortality to composition 1. Importantly, composition 3 with 150 ppm added TEHP in the tank mix shows similar insect mortality to composition 7 containing built in TEHP and similar level of TEHP in the tank mix. Tank mix composition 5, containing the same level of MSO in the tank mix did not provide insect control. The results in Table 4C manifest the leaf penetration power of TEHP at low concentrations compared to MSO, which enables higher active ingredient loadings in the formulations containing TEHP. In contrary, it is believed that a high active ingredient strength formulation with MSO will not contain enough MSO to maintain biological efficacy.

### Example 5

### Example 5A

Oil dispersion (OD) compositions comprising chlorantraniliprole were prepared as summarized in Table 5A below, wherein all amounts are reported as percent of the total formulation (% w/w).

TABLE 5A

| | Composition | | | | |
|---|---|---|---|---|---|
| Ingredient | 16 | 17 | 18 | 19 | 20 |
| Chlorantraniliprole | 30 | 30 | 30 | 30 | 30 |
| Atlox 4914 | 2 | 2 | 2 | 2 | 2 |
| Agnique 60 C ABS EH | 8 | 8 | 8 | 8 | 8 |
| Cirrasol G-1096 | 10 | 10 | 10 | 10 | 10 |
| Break Thru S 240 | 5 | — | — | — | — |
| Tergitol 15-S-7 | — | 5 | — | — | — |
| Ecosurf EH-6 | — | — | 5 | — | — |
| Silwet HS 312 | — | — | — | 5 | — |
| Lutensol XL 50 | — | — | — | — | 5 |
| DISFLAMOLL TOF (TEHP) | 45 | 45 | 45 | 45 | 45 |
| Total | 100 | 100 | 100 | 100 | 100 |
| TEHP:Chlorantraniliprole | 1.5:1 | 1.5:1 | 1.5:1 | 1.5:1 | 1.5:1 |

Compositions 16-20 also showed good dispersibility in water and good spontaneity of blooming. Addition of at least one of the following components selected from Break Thru S 240, Tergitol 15-S-7, Ecosurf EH-6, Silwet HS 312, and Lutensol XL 50 improves both dispersibility and spontaneity of blooming.

### Example 5B

The efficacy on Trichoplusia ni of the formulation compositions 16-20 of Example 5A, containing built in TEHP, were evaluated according to Method 1 versus chlorantraniliprole as a commercially available SC formulation which does not contain built in TEHP. All formulations were applied at a rate of 100 ppm of chlorantraniliprole. The results are provided in Table 5B below where “CTPR” refers to Chlorantraniliprole and “Comp” refers to Composition.

TABLE 5B

| Comp | CTPR | % Mortality |
|---|---|---|
| 16 | 100 ppm | 100 |
| 17 | 100 ppm | 90 |
| 18 | 100 ppm | 90 |
| 19 | 100 ppm | 100 |
| 20 | 100 ppm | 80 |
| Commercial SC | 100 ppm | 15 |
| formulation | | |

The results indicate that, at 100 ppm chlorantraniliprole, compositions 16-20 containing built in TEHP show higher insect mortality in the soybean translaminar test compared to a SC composition that does not contain TEHP.

### Example 5C

Soybean response to the chlorantraniliprole compositions 16-20 of Example 5A was evaluated according to method 2. No phytotoxicity was observed after 7 DAT.

### Example 6

### Example 6A

Oil dispersion (OD) compositions comprising chlorantraniliprole were prepared as summarized in Table 6A below, wherein all amounts are reported as percent of the total formulation (% w/w).

TABLE 6A

| | Composition | | | | | | | |
|---|---|---|---|---|---|---|---|---|
| Ingredient | 21 | 22 | 23 | 24 | 25 | 26 | 30 | 31 |
| Chlorantraniliprole | 30 | 30 | 30 | 30 | 30 | 30 | 30 | 30 |
| Atlox 4914 | 2 | 2 | 2 | 2 | 2 | 2 | 2 | 2 |
| Agnique 60 C ABS EH | 8 | 6 | 8 | 8 | 8 | 6 | 6 | 6 |
| Cirrasol G-1096 | 10 | 10 | 10 | 10 | 10 | 10 | 10 | 10 |
| Break Thru S 240 | 5 | 5 | 3 | — | — | 5 | 5 | 5 |
| Tergitol 15-S-7 | — | — | — | 3 | — | — | — | — |
| Lutensol XL 50 | — | — | — | — | 3 | — | — | — |
| DISFLAMOLL TOF (TEHP) | 44 | 46 | 45 | 45 | 45 | 47 | 45.5 | 45.5 |
| Aerosil 200 | — | — | — | — | — | — | 1 | — |
| Aerosil R974 | — | — | — | — | — | — | — | 1 |
| Atlox 4915 | — | — | — | — | — | — | 0.5 | 0.5 |
| Water | 1 | 1 | 2 | 2 | 2 | 0 | 0 | 0 |
| Total | 100 | 100 | 100 | 100 | 100 | 100 | 100 | 100 |
| TEHP:Chlorantraniliprole | 1.5:1 | 1.5:1 | 1.5:1 | 1.5:1 | 1.5:1 | 1.6:1 | 1.5:1 | 1.5:1 |
| % Mortality (Method 1) | 95 | 100 | Not | Not | Not | Not | Not | Not |
| | | | tested | tested | tested | tested | tesetd | tested |

### Example 6B

The efficacy on Trichoplusia ni of the formulation compositions 16, 21 and 22, which according to the present invention contain built in TEHP, was evaluated according to Method 1 versus chlorantraniliprole as a commercially available SC formulation which does not contain built in TEHP. All formulations were applied at a rate of 100 ppm of chlorantraniliprole. The results are provided in Table 6B below where “CTPR” refers to Chlorantraniliprole and “Eval” refers to Evaluation.

TABLE 6B

| Eval | CTPR | Composition | % Mortality |
|---|---|---|---|
| 1 | 100 ppm | 16 | 95 |
| 2 | 100 ppm | 21 | 95 |
| 3 | 100 ppm | 22 | 100 |
| 4 | 100 ppm | Commercial SC | 0 |
| | | formulation | |

The results indicate that, at 100 ppm chlorantraniliprole, compositions 16, 21 and 22 containing built in TEHP show higher insect mortality in the soybean translaminar test compared to a SC composition that does not contain TEHP. Compositions in Table 6A, which were not tested by method 1, are expected to show similar performance as compositions 21 and 22 in Table 6B. Compositions 21-31 also showed good dispersibility in water and good spontaneity of blooming.

### Example 7

The rainfastness of compositions 8 and 9 (Table 1E) and of compositions 11 and 13 (Table 1F) were evaluated according to Method 5 versus chlorantraniliprole as a commercially available SC formulation which does not contain built in TEHP. The results are provided in Table 7 below where “CTPR” refers to Chlorantraniliprole and “Comp” refers to composition.

TABLE 7

| Comp | CTPR | Simulated Rain | % Mortality |
|---|---|---|---|
| 8 | 100 ppm | No | 90 |
| 9 | 100 ppm | No | 90 |
| 11 | 100 ppm | No | 100 |
| 13 | 100 ppm | No | 100 |
| Commercial SC | 100 ppm | No | 15 |
| formulation | | | |
| 8 | 100 ppm | Yes | 85 |
| 9 | 100 ppm | Yes | 90 |
| 11 | 100 ppm | Yes | 85 |
| 13 | 100 ppm | Yes | 70 |
| Commercial SC | 100 ppm | Yes | 5 |
| formulation | | | |

The results indicate that all compositions containing TEHP showed enhanced insect mortality compared to the comparative SC composition which does not contain TEHP. After simulated rain, the compositions with built in TEHP retain the enhanced insect mortality compared to the comparative SC composition. The results demonstrate good rainfastness of the formulations with built in TEHP.

### Example 8

### Example 8A: SE Formulations of Chlorantraniliprole

Suspoemulsion compositions (SE) comprising chlorantraniliprole were prepared as summarized in Table 8A below, wherein all amounts are reported as percent of the total formulation (% w/w).

TABLE 8A

| | Composition | | |
|---|---|---|---|
| Ingredient | 27 | 28 | 29 |
| Chlorantraniliprole | 5 | 5 | 5 |
| Propylene Glycol | 4.5 | 4.5 | 4.5 |
| Atlox 4913 | 3 | 3 | 3 |
| Atlox 4894 | 2 | 2 | 2 |
| Water | 28.25 | 38.26 | 28.25 |
| Acti-Gel 208 | 1.5 | 1.5 | 1.5 |
| Acticide LA 1209 | 0.1 | 0.1 | 0.1 |
| Agnique DFM 111S | 0.5 | 0.5 | 0.5 |
| Grinsted Xanthan 80 | 0.15 | 0.15 | 0.15 |
| DISFLAMOLL TOF (TEHP) | 46.75 | 21.25 | 17.15 |
| Agnique 60 C ABS EH | 4.125 | 1.87 | 3.75 |
| Cirrasol G 1086 | 4.125 | 1.87 | 3.75 |
| Synergen W06 | — | 20 | — |
| Agnique BP 420 | — | — | 10 |
| Total | 100 | 100 | 100 |
| TEHP:Chlorantraniliprole | 9.4:1 | 4.3:1 | 3.4:1 |

### Example 8B

The efficacy on Trichoplusia ni of the formulation SE compositions 27, 28 and 29 of the present disclosure, containing built in TEHP, were evaluated according to Method 1 versus composition C5 as a commercially available SC formulation which does not contain built in TEHP and versus OD composition 1, which contains built in TEHP. All formulations were applied at a rate of 100 ppm of chlorantraniliprole. The results are provided in Table 8B below where “CTPR” refers to Chlorantraniliprole.

TABLE 8B

| Composition | CTPR | Formulation Type | % Mortality |
|---|---|---|---|
| 27 | 100 ppm | SE with built in TEHP | 100 |
| 28 | 100 ppm | SE with built in TEHP | 65 |
| 29 | 100 ppm | SE with built in TEHP | 80 |
| 1 | 100 ppm | OD with built in TEHP | 90 |
| C5 | 100 ppm | SC without TEHP | 0 |

The results indicate that, at 100 ppm chlorantraniliprole, both the SE compositions 27-29 and the OD composition 1 containing built in TEHP show higher insect mortality in the soybean translaminar test compared to a SC composition that does not contain TEHP.

### Example 9

### Example 9A

Compositions containing cyantraniliprole and TEHP were evaluated for efficacy on whitefly versus cyantraniliprole in the absence of TEHP according to Method 4. The results are reported in Table 9A below where “A1” refers to the concentration of cyantraniliprole in ppm in the applied formulations, “TEHP/Cyantraniliprole” refers to the weight ratio of TEHP to cyantraniliprole, and C1 refers to a comparative composition. Cyantraniliprole efficacy showed clearly dose response to TEHP/Cyantraniliprole ratio in Table 9A.

TABLE 9A

| | Composition | | | | | |
|---|---|---|---|---|---|---|
| | 1 | 2 | 3 | 4 | 5 | C1 |
| Ingredient | Wt. % | Wt. % | Wt. % | Wt. % | Wt. % | Wt. % |
| Polyfon F | 0.33% | 0.67% | 1.00% | — | — | — |
| Atlox LP-1 | 0.67% | 1.33% | 2.00% | 1.80% | 1.50% | — |
| Cirrasol G-1086 | 6.10% | 4.70% | 4.80% | — | — | — |
| Agnique DBS 60 | 6.10% | 4.70% | 4.80% | 5.00% | 4.00% | — |
| Atlas G5002L | — | — | — | 1.70% | 1.40% | — |
| Stepwet DOS70 | — | — | — | 0.80% | 0.60% | — |
| Breakthru SP133 | — | — | — | 24.40% | 19.80% | — |
| OD Formulation Inert | — | — | — | — | — | 90% |
| Cyantraniliprole | 10.32% | 20.64% | 30.98% | 24.70% | 20.00% | 10% |
| TEHP | 76.48% | 67.96% | 56.42% | 41.60% | 52.60% | 0 |
| TEHP/Cyantraniliprole | 7.41 | 3.29 | 1.82 | 1.68 | 2.63 | 0 |
| White fly mortality, | 83% | 81% | 51% | n/a | n/a | 31% |
| (AI: 250 ppm) | | | | | | |
| White fly mortality, | n/a | 83% | 47% | 55% | 67% | 3% |
| (AI: 125 ppm) | | | | | | |

### Example 9B

Further compositions containing cyantraniliprole and TEHP and other formulation components were further evaluated according to the method 4 and compared to comparative composition C1 of Example 9A. In each evaluation, cynatraniliprole was applied at a cyanatraniliprole concentration of 250, 125 and 62.5 ppm. The results are reported in Table 9B below. Cyantraniliprole efficacy was not negatively effected by other ingredients, and the efficacies are better than comparative OD formulation C1 without TEHP.

TABLE 9B

| | Composition | | | | |
|---|---|---|---|---|---|
| | 6 | 7 | 8 | 9 | |
| Ingredient | Wt. % | Wt. % | Wt. % | Wt. % | C1 |
| Cyantraniliprole | 16.8% | 17.3% | 20.6% | 20.6% | |
| TEHP | 42.0% | 43.0% | 43.6% | 46.0% | |
| Agnique CSO 30 | 12.2% | 12.6% | 15.0% | 15.0% | |
| Rhodacal 60 BE | 6.2% | 6.4% | 10.0% | 10.0% | |
| Atlox LP-1 | 1.6% | 1.7% | 3.0% | 3.0% | |
| Brij CS17 | — | — | 8.0% | — | |
| Propylene carbonate | — | 5.3% | — | — | |
| Sunspray 6N | 21.1% | 13.7% | — | — | |
| Break thru S240 | — | — | — | 5.0% | |
| TEHP/Cyantraniliprole | 2.5 | 2.5 | 2.1 | 2.2 | |
| White fly mortality, | 95% | 98% | 99% | 96% | 80% |
| AI = 250 PPM | | | | | |
| White fly mortality, | 89% | 96% | 91% | 68% | 82% |
| AI = 125 PPM | | | | | |
| White fly mortality, | 74% | 86% | N/A | N/A | 33% |
| AI = 62.5 PPM | | | | | |

### Example 10: Suspoemulsion (SE) Formulation of Cyantraniliprole

Suspoemulsion formulation of Cyantraniliprole was also prepared containing TEHP as adjuvant as follows. A 46% SC formulation of cyantraniliprole was obtained by milling cyantraniliprole in the presence of e.g., Atlox 4913, Destrol OC-180, Agnique PG9116, propylene glycol, citric acid and water (Composition 1). A 43% EW formulation of TEHP was obtained by homogenizing TEHP in the presence of Atlox 4914, Atlas G5000L in water. Under agitation, the Cyantraniliprole SC formulation was mixed with TEHP EW formulation, resulting in the final SE formulation. The SE formulation can also be made by adding the TEHP EC formulation containing emulsifiers such as Atlox 4914 and Atlas G5002L to the SC formulation under agitation or emulsification. SE composition 1 was evaluated for efficacy on whitefly versus cyantraniliprole in the absence of TEHP (C1) according to Method 4 above with the exception that the whiteflies were 3^{rd} instar nymphs, the plants were sprayed 10 days after infestation, and morality was evaluated at 4 DAT. The results are reported in Table 10 below where “AI” refers to the concentration of cyanatraniliprole in ppm in the applied formulations, and “TEHP/Cyantraniliprole” refers to the weight ratio of TEHP to cyantraniliprole. SE formulation compositions can further be modified in a way as described in OD formulations described above.

TABLE 10

Composition

| | 1 | C1 |
|---|---|---|
| Ingredient | Wt. % | Wt. % |
| Cyantraniliprole | 22.5% | 10% |
| Atlox 4913 | 1.2% | |
| Agnique PG9116 | 1.0% | |
| Dextrol OC-180 | 1.3% | |
| PropyleneGlycol | 5.2% | |
| Tris(2-ethylhexyl)phohphate (TEHP) | 21.8% | 0 |
| Atliox 4914 | 2.4% | |
| Water | 41.9% | |
| Atlas G5000 | 2.4% | |
| Citric acid | 0.12% | |
| TEHP/Cyantraniliprole | 1:1 | 0 |
| White fly mortality (250 ppm) | 88% | 69% |

The results indicate that the cyantraniliprole SE formulation containing TEHP showed improved efficacy over comparative OD formulation without TEHP.

### Example 11: Translocation of Liquid Formulations Described Herein in Leaves

An oil dispersion (OD) composition comprising chlorantraniliprole was prepared as summarized in Table 6A, wherein all amounts are reported as percent of the total formulation (% w/w). Soybean leaves were treated according to method 7. A control treatment comprising Coragen® insect control was also included in the studies. The results are reported in Table 11 below.

TABLE 11

| | | Mortality (%) | | | | Feeding (%) | | | |
|---|---|---|---|---|---|---|---|---|---|
| | Rate | Treated | | Untreated | | Treated | | Untreated | |
| | (ppm) | Area | | Area | | Area | | Area | |
| Composition | 250 | 100.1 | a | 95.8 | a | 0.3 | c | 0.6 | c |
| 26 | | | | | | | | | |
| Coragen ® | 250 | 96.9 | a | 18.8 | b | 25.0 | b | 75.6 | b |
| insect Control | | | | | | | | | |
| UTC | | 7.3 | b | 6.3 | b | 95.6 | a | 96.3 | a |

The results indicate that significantly higher mortality and less feeding were observed in the untreated areas of leaves treated with Composition 26, compared with the control treatment. Additionally, significantly less feeding was also observed in the treated areas of leaves treated with Composition 26, compared with the control treatment. Without intending to be limited to any particular theory, compositions of the present disclosure show improved translaminar translocation, causing significantly higher larval mortality and reduced feeding. Additionally, translaminar translocation may compensate for poor leaf coverage.

### Example 12: Translocation of Liquid Formulations Described Herein in Petioles

An oil dispersion (GD) composition comprising chlorantraniliprole was prepared as summarized in 6A, wherein all amounts are reported as percent of the total formulation (% w/w). Soybean leaves were treated according to method 8. A control treatment comprising Coragen® insect control was also included in the studies. The results are reported in Tables 12 and 13 below.

TABLE 12

| | | | |
|---|---|---|---|
| | | Mortality (%) | Feeding (%) |
| | Rate | 1^{st} | 1^{st} |
| Petioles | (ppm) | Trifoliate | Trifoliate |

| | | | | | |
|---|---|---|---|---|---|
| Composition | 250 | 64.5 | a | 18 | b |
| 26 | | | | | |
| Coragen ® | 250 | 6.9 | b | 98 | a |
| insect | | | | | |
| Control | | | | | |
| UTC | | 2.5 | b | 98 | a |

The results indicate that significantly higher mortality and less feeding were observed on leaves treated with Composition 26, compared with the control treatment.

TABLE 13

| | | | |
|---|---|---|---|
| | | Mortality (%) | Feeding (%) |
| | Rate | 1^{st} | 1^{st} |
| Stem | (ppm) | Trifoliate | Trifoliate |

| | | | | | |
|---|---|---|---|---|---|
| Composition | 250 | 36.4 | a | 17 | b |
| 26 | | | | | |
| Coragen ® | 250 | 3.3 | ab | 89.6 | a |
| insect | | | | | |
| Control | | | | | |
| UTC | | 0 | b | 69.2 | a |

The results indicate that significantly less feeding was observed on leaves treated with Composition 26, compared with the control treatment. Mortality was also higher on leaves treated with Composition 26, compared with the control treatment.

Without intending to be limited to any particular theory, taken together, these data suggest that compositions of the present disclosure show improved translocation from either the stem or petiole into the leaflets of plants, causing significantly higher larval mortality and reduced feeding. Additionally, translocation may compensate for poor leaf coverage.

### Example 13: Application of an OD Formulation to Rice Via Unmanned Drone

An oil dispersion (OD) composition comprising chlorantraniliprole was prepared as summarized in 6A, wherein all amounts are reported as percent of the total formulation (% w/w). A transplanted rice crop was treated according to method 9. A control treatment comprising Prevathon® 50SC insect control was also included in the studies. The results are reported in Tables 14 and 15 below.

TABLE 14

| | % Deadheart Evaluation | | | |
|---|---|---|---|---|
| | Composition | Composition | Prevathon ® | |
| Days after | 26 | 26 | 50SC insect | |
| application | 15 gah | 30 gah | control 30 gah | UTC |
| 3 | 6.9 | 5.0 | 4.5 | 11.1 |
| 7 | 19.0 | 13.1 | 12.6 | 25.2 |
| 10 | 23.0 | 15.7 | 14.6 | 31.3 |
| 14 | 19.7 | 16.0 | 16.0 | 35.8 |
| 21 | 17.1 | 15.3 | 14.5 | 33.5 |
| 28 | 15.0 | 14.7 | 12.5 | 29.2 |

TABLE 15
(% of Control)

| | % Deadheart Evaluation | | | |
|---|---|---|---|---|
| | Composition | Composition | Prevathon ® | |
| Days after | 26 | 26 | 50SC insect | |
| application | 15 gah | 30 gah | control 30 gah | UTC |
| 7 | 24.3 | 47.9 | 50.1 | |
| 10 | 26.5 | 49.7 | 53.4 | |
| 14 | 44.9 | 55.3 | 55.4 | |
| 21 | 49.1 | 54.5 | 56.0 | |
| 28 | 48.6 | 49.5 | 57.2 | |

The results indicate that there was no significant difference in the efficacy of the composition 26 treatment, compared with the control treatment, applied at 30 grams of active per hectare.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An insecticidal oil concentrate composition, the composition comprising:
(1) from about 2 wt. % to about 50 wt. % of a at least one diamide insecticide active ingredient; and
(2) a phosphate ester of formula (I) 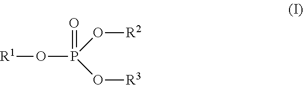
wherein
R¹ is a straight-chain or branched alkyl having from 4 to 12 carbon atoms, or a phenyl group optionally substituted with from 1 to 3 C₁₋₄ straight-chain or branched alkyl groups, and
R² and R³ are each independently a straight-chain or branched alkyl having from 2 to 8 carbon atoms, or a phenyl group optionally substituted with from 1 to 3 C₁₋₄ straight-chain or branched alkyl groups,
wherein the weight ratio of the phosphate ester to diamide insecticide is from about 0.1:1 to about 20:1, except when the diamide insecticide is cyantraniliprople, the weight ratio of the phosphate ester to cyantraniliprople is from about 0.4:1 to about 20:1.

2. The composition of claim 1 wherein the diamide insecticide is selected from the group consisting of chlorantraniliprole, cyantraniliprole, tetrachlorantraniliprole, bromoantraniliprole, dichlorantraniliprole, tetraniliprole, cyclaniliprole, cyhalodiamide and flubendiamide.

3. The composition of claim 1, wherein the concentrate is selected from an oil dispersion composition, an emulsifiable concentrate composition, a dispersible concentrate composition, a suspension concentrate composition, and a suspoemulsion.

4. The composition of claim 1, further comprising at least one additional pest control agent.

5. The composition of claim 4 wherein the additional pest control agent selected from an insecticide, a herbicide, a bactericide, a fungicide, a nematicide, and combinations thereof.

6. The composition of claim 5, wherein the insecticide is selected from abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos-methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cycloprothrin, cycloxaprid ((5S,8R)-1-[(6-chloro-3-pyridinyl)methyl]-2,3,5,6,7,8-hexahydro-9-nitro-5,8-Epoxy-1H-imidazo[1,2-a]azepine), cyenopyrafen, cyflumetofen, cyfluthrin, beta-cyfluthrin, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy)phenoxy]-4-quinolinyl methyl carbonate), flonicamid, fluazaindolizine, flucythrinate, flufenerim, flufenoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, tau-fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, oxamyl, oxazosulfyl, parathion, parathion-methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ⁴-sulfanylidene]cyanamide), tebufenozide, tebufenpyrad, teflubenzuron, tefluthrin, kappa-tefluthrin, terbufos, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entomopathogenic fungi, can combinations thereof.

7. The composition of claim 1, wherein the phosphate ester is selected from the group consisting of trixylenyl phosphate, butylatated phenol phosphate, tris(isopropylphenyl) phosphate, cresyl diphenyl phosphate, isopropylphehyl diphenyl phosphate, t-butylphenyl diphenyl phosphate, 2-ethylhexyl, diphenyl phosphate, iosdecyl diphenyl phosphate, tri-n-butyl phosphate, tri-n-pentyl phosphate, tri-n-hexyl phosphate, tri-n-heptyl phosphate, tri-n-octyl phosphate, nonyl dioctyl phosphate, butyl dioctyl phosphate, dibutyl nonyl phosphate, butan-2-yl dibutyl phosphate, butan-2-yl diethyl phosphate, butan-2-yl bis(2-methylpropyl) phosphate, 3-methylbutyl dipropan-2-yl phosphate, tris-(2-ethylhexyl)phosphate, tri-iso-butyl phosphate, tributoxylethyl phosphate, and combinations thereof.

8. The composition of claim 7, wherein the phosphate ester is selected from tris-(2-ethylhexyl)phosphate, tri-n-octyl phosphate, and tri-iso-butyl phosphate.

9. The composition of claim 8, wherein the phosphate ester is tris-(2-ethylhexyl)phosphate.

10. The composition of claim 1, wherein the weight ratio of phosphate ester to diamide insecticide is from about 0.5:1 to about 15:1, from about 0.75:1 to about 10:1, from about 1:1 to about 5:1, or from about 1.5:1 to about 3:1.

11. The composition of claim 1, wherein the surfactant is selected from: polyether-modified polysiloxanes; copolymers of polyolefin; polyoxyethylene sorbitol fatty acid esters; alkyl benzene sulfonates; alcohol ethoxylates; alcohol mixed ethoxylates and propoxylates; oxirane surfactants; polyglycerol esters and fatty acid esters; oil; and combinations thereof.

12. The composition of claim 1, wherein the diamide insecticide is chlorantraniliprole.

13. The composition of claim 1, wherein the diamide insecticide is cyantraniliprole.

14. The composition of claim 1, further comprising an oil, wherein the total oil content is from about from about 10 wt. % to about 40 wt. %, from about 10 wt. % to about 30 wt. %, or from about 10 wt. % to about 20 wt. %.

15. A tank mix formulation comprising the composition of claim 1 and a diluent, wherein the diamide insecticide concentration is less than 5 wt. %, from about 0.005 wt. % to about 4 wt. %, from about 0.01 wt. % to about 1 wt. %, from about 0.01 wt. % to about 0.1 wt. %, or from about 0.01 wt. % to about 0.05 wt. %.

16. A tank mix formulation comprising:
(1) less than 5 wt. % of a diamide insecticide active ingredient;
(2) a phosphate ester of formula (I) 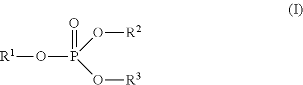
wherein
R¹ is a straight-chain or branched alkyl having from 4 to 12 carbon atoms, or a phenyl group optionally substituted with from 1 to 3 C₁₋₄ straight-chain or branched alkyl groups, and
R² and R³ are each independently a straight-chain or branched alkyl having from 2 to 8 carbon atoms, or a phenyl group optionally substituted with from 1 to 3 C₁₋₄ straight-chain or branched alkyl groups; and
(3) a diluent,
wherein the weight ratio of the phosphate ester to diamide insecticide is from about 0.1:1 to about 100:1, except when the diamide insecticide is cyantraniliprople, the weight ratio of the phosphate ester to cyantraniliprople is from about 0.4:1 to about 100:1.

17. The tank mix formulation of claim 16, wherein the diamide insecticide is selected from the group consisting of chlorantraniliprole, cyantraniliprole and flubendiamide.

18. The tank mix formulation of claim 16, wherein the phosphate ester is selected from the group consisting of trixylenyl phosphate, butylatated phenol phosphate, tris(isopropylphenyl) phosphate, cresyl diphenyl phosphate, isopropylphehyl diphenyl phosphate, t-butylphenyl diphenyl phosphate, 2-ethylhexyl, diphenyl phosphate, iosdecyl diphenyl phosphate, tri-n-butyl phosphate, tri-n-pentyl phosphate, tri-n-hexyl phosphate, tri-n-heptyl phosphate, tri-n-octyl phosphate, nonyl dioctyl phosphate, butyl dioctyl phosphate, dibutyl nonyl phosphate, butan-2-yl dibutyl phosphate, butan-2-yl diethyl phosphate, butan-2-yl bis(2-methylpropyl) phosphate, 3-methylbutyl dipropan-2-yl phosphate, tris-(2-ethylhexyl)phosphate, tri-iso-butyl phosphate, and combinations thereof.

19. A method of controlling phytophagous pests on plants, the method comprising applying the tank mix of claim 16 to a plurality of the plants,
wherein the tank mix is applied to the plants at a rate sufficient to achieve a total amount of applied diamide insecticide of from about 50 grams per hectare to about 500 grams per hectare, and
wherein the mortality of a plurality of the sucking pests is at least 75% evaluated at three days after exposure to the active ingredient.

20. The method of claim 19, wherein the phytophagous pest is selected from the insect orders, including Hemiptera, Thysanoptera, Orthoptera, Lepidoptera, Coleoptera, Heteroptera, Hymenoptera, and Diptera.
